(19) United States
(12) Patent Application Publication
(10) Pub. No.: US 2005/0150778 A1
(43) Pub. Date: Jul. 14, 2005

(54) Use of basic polymers in carbon black composite vapor detectors to obtain enhanced sensitivity and classification performance for volatile fatty acids

(76) Inventors: Nathan S. Lewis, La Canada, CA (US); Robert H. Grubbs, South Pasadena, CA (US); Eric Steven Tillman, Lewisburg, PA (US); Michael E. Koscho, Starkville, MS (US)

Correspondence Address: FISH & RICHARDSON, PC, 12390 EL CAMINO REAL, SAN DIEGO, CA, 92130-2081, US

(21) Appl. No.: 10/980,901

(22) Filed: Nov. 18, 2003

Related U.S. Application Data
(60) Provisional application No. 60/427,315, filed on Nov. 18, 2002.

(51) Int. Cl. G01N 27/26

(52) U.S. Cl. 205/777.5; 204/403.01

(57) ABSTRACT

Provided are sensors, sensor arrays, and systems for detecting an analyte. A sensor provided by the disclosure comprises an amine-containing material. Such sensors are useful to detect carboxylic-containing analytes such as fatty acids.

### CROSS REFERENCE TO RELATED APPLICATIONS

This application claims priority under 35 U.S.C. §119 from Provisional Application Serial No. 60/427,315, filed Nov. 18, 2002, the disclosure of which is incorporated herein by reference.

### STATEMENT AS TO FEDERALLY-SPONSORED RESEARCH

The U.S. Government has certain rights in this invention pursuant to Grant No. DAAG-55-98-1-0266 awarded by the Army Research Office and Grant No. R01 DC04712-02 awarded by the National Institute of Health.

### FIELD OF THE INVENTION

This invention relates generally to sensors and sensor systems for detecting analytes in fluids and, more particularly, to sensor systems that incorporate sensors having electrical properties that vary according to the presence and concentration of analytes, and to methods of using such sensor systems.

### BACKGROUND

There is considerable interest in developing sensors that act as analogs of the mammalian olfactory system (Lundstrom et al. (1991) Nature 352:47-50; Shurmer and Gardner (1992) Sens. Act. B 8:1-11; Shurmer and Gardner (1993) Sens. Actuators B 15:32).

Prior attempts to produce a broadly responsive sensor array have exploited heated metal oxide thin film resistors (Gardner et al. (1991) Sens. Act. B4:117-121; Gardner et al. (1991) Sens. Act. B 6:71-75), polymer sorption layers on the surfaces of acoustic wave resonators (Grate and Abraham (1991) Sens. Act. B 3:85-111; Grate et al. (1993) Anal. Chem. 65:1868-1881), arrays of electrochemical detectors (Stetter et al. (1986) Anal. Chem. 58:860-866; Stetter et al. (1990) Sens. Act. B 1:43-47; Stetter et al. (1993) Anal. Chem. Acta 284:1-11), conductive polymers or composites that consist of regions of conductors and regions of insulating organic materials (Pearce et al. (1993) Analyst 118:371-377; Shurmer et al. (1991) Sens. Act. B 4:29-33; Doleman et al. (1998) Anal. Chem. 70:2560-2654; Lonergan et al. Chem. Mater. 1996, 8:2298). Arrays of metal oxide thin film resistors, typically based on tin oxide (SnO₂) films that have been coated with various catalysts, yield distinct, diagnostic responses for several vapors (Corcoran et al. (1993) Sens. Act. B 15:32-37). However, due to the lack of understanding of catalyst function, SnO₂ arrays do not allow deliberate chemical control of the response of elements in the arrays nor reproducibility of response from array to array. Surface acoustic wave resonators are extremely sensitive to both mass and acoustic impedance changes of the coatings in array elements. Attempts have also been made to construct arrays of sensors with conducting organic polymer elements that have been grown electrochemically through use of nominally identical polymer films and coatings. Moreover, Pearce et al., (1993) Analyst 118:371-377, and Gardner et al., (1994) Sensors and Actuators B 18-19:240-243 describe, polypyrrole based sensor arrays for monitoring beer flavor. Shurmer (1990) U.S. Pat. No. 4,907,441, describes general sensor arrays with particular electrical circuitry. U.S. Pat. No. 4,674,320 describes a single chemoresistive sensor having a semi-conductive material selected from the group consisting of phthalocyanine, halogenated phthalocyanine and sulfonated phthalocyanine, which was used to detect a gas contaminant. Other gas sensors have been described by Dogan et al., Synth. Met. 60, 27-30 (1993) and Kukla, et al. Films. Sens. Act. B., Chemical 37, 135-140 (1996).

Sensor arrays formed from a plurality of composites that consist of regions of a conductor and regions of an insulating organic material, usually an organic polymer as described in U.S. Pat. No. 5,571,401, have some advantages relative to the approaches described above, however there is a need for sensors and sensor materials that show dramatically improved detection sensitivity if the sensors and the sensing devices are to be as sensitive as the human olfactory system towards certain classes of compounds, such as carboxylic acids. Certain odors have typically been missed by an electronic nose that is not responsive to such odors and such a device will not be acceptable to detect and classify odors that are perceived by humans or at levels that are desirable for food freshness, biomedical, disease state identification, and other applications.

Breath testing, for example, has long been recognized as a nonintrusive medical technique that allows for diagnosis of disease or the presence of analytes. Presently, the techniques utilized for the evaluation of breath are gas chromatography with flame photometric detection (FPD), GC/MS (mass spectrometry), the Halimeter, microbiological testing, and organoleptic scores (Spielman, 1998). Both GC/FPD and GC/MS are quantitative techniques, with GC/MS having the added advantage of identifying the individual components of analyzed breath. However, both of these instruments are costly and time intensive, which limits their use in common practice. The Halimeter is a portable, electrochemically-based sulfide monitor introduced within the last decade to monitor for halitosis by measuring the concentration of sulfur containing compounds semiquantitatively at the part per billion level. However, one drawback is that the Halimeter is unable to detect individual sulfur compounds, because it is comprised of a single sensor that responds to the general class of sulfur containing compounds, such as hydrogen sulfide and methylmercaptan. Furthermore, it is unable to detect many other objectionable odoriferous compounds such as indole, skatole, volatile fatty acids, and amines, which are present in breath of halitosis patients. Additionally, the halimeter sensor is not entirely selective because it also responds to alcohols such as ethanol. In addition, it cannot detect the presence of volatile amines volatile fatty acids, or other compounds that are of interest in disease other than certain types of halitosis. Odor panels have been utilized efficiently in some cases for the analysis of disease. Some of the drawbacks are of course that odor panels consist of humans that are genetically capable and highly trained, and that the scores are subjective.

Although the foregoing systems have some usefulness, there still remains a need in the art for a low cost sensors and sensor arrays for analyte detection.

### SUMMARY

The artificial olfactory system (or electronic nose) described herein uses a sensor and/or sensor array to recognize a single odorant. The sensors, sensor arrays and systems described herein fulfills this and other needs. The disclosure provides a broadly responsive analyte detection sensor and sensor array based on a variety of sensor elements. Such elements are simply prepared and are readily modified chemically to respond to a broad range of analytes. In one aspect, these sensors yield a rapid, low-power, dc electrical signal in response to an analyte of interest, and their signals are readily integrated with software- or hardware-based algorithms including neural networks for purposes of analyte identification.

Upon exposure to carboxylic acid-containing compounds (e.g., fatty acids and the like), sensors comprising an amine-containing material such as a linear poly(ethylenimine) (l-PEI)-carbon black composite showed unexpected increase in signal/noise of >10³ relative to the performance of typical insulating organic polymer-carbon black composite sensor. Compositional diversity in an array of such sensors is obtained by varying the degree of plasticization of the l-PEI films. The resulting sensor array produced sensitive detection of, and robust discrimination between, various volatile fatty acids, and relatively little response from non-acidic organic vapors or from water vapor. Measurements of the mass uptake, thickness change, and electrical conductivity of such composites allowed quantification of the relative contributions of electrical percolation effects, increases in analyte sorption, and charge-induced swelling to the enhanced sensitivity of l-PEI composites toward volatile fatty acid vapors.

In addition, there is provided individual sensor materials that display enhanced sensitivity towards certain specific compounds of interest, such as, for example, carboxylic acid containing compounds including fatty acids and the like. The sensor comprises regions of an amine-containing material (e.g., a polyimine) and regions of a conductive material, wherein the sensor provides an electrical path through the regions of the amine-containing material and the conductive material, the sensors constructed to provide a first response when contacted with a first chemical analyte and a second different response when contacted with a second different chemical analyte. In one embodiment, the amine-containing material is selected from the group consisting of polyimines, polyallylamine, polyvinylamine, polyhistidine, polyomithine, polylysine, and polyarginine. Examples of polyimine materials useful in the sensors described herein include poly(acetyliminoethylene), polyethylenimine, and poly(valeryl-iminoethylene) and derivatives thereof, and the conductive material is selected from the group consisting of Ag, Au, Cu, Pt, AuCu, and carbon black, as well as conductive organic polymers. These sensors can be used by themselves or in conjunction with other sensor modalities (e.g., surface acoustic wave device, electrochemical gas sensors, and the like) to increase the performance and information content of sensor arrays for detection of analytes in a sample.

Also provided by the disclosure is a sensor array comprising a plurality of sensors and a measuring apparatus, wherein the sensor are in communication with the measuring apparatus, at least one of the sensors comprising regions of an amine-containing material and regions of a conductive material, wherein said sensor provides an electrical path through the regions of the amine-containing material and the conductive material, the sensors constructed to provide a first response when contacted with a first chemical analyte and a second, different response when contacted with a second different chemical analyte.

### BRIEF DESCRIPTION OF THE FIGURES

These and other objects will now be described in detail with reference to the accompanying drawing, in which:

FIG. 1A-D depicts various diagrams of sensor and sensor arrays as described in the disclosure.

FIG. 2 shows is a plot showing exposure of insulating polymer-carbon black composite chemiresitors to 160 ppm acetic acid vapor, shown as ΔR/R_{b} as a function of time. The polymers are (a) polysulfone, (b) polyetylen-co-vinyl acetate (45% vinyl acetate), (c) polycarolactone, (d) polystyrene-butadiene tri-block (30% styrene), (e) poly(ethylene oxide), (f) poly(N-vinylpyrrolidone), (g) poly(4-vinylpyridine), and (h) linear poly(ethylenimine).

FIG. 3 shows a plot of the exposure of linear poly(ethylenimine)-carbon black (4:1 mass ratio in casting solution) composite chemiresistor to various volatile organic analytes and water. The vapors indicated are (a) acetone (12.1 ppth), (b) chloroform (10.1 ppth), (c) toluene (1.4 ppth), (d) ethanol (3.0 ppth), (e) methanol (6.2 ppth), water (1.2 ppth), and acetic acid (160 ppm). The inset displays an expanded scale of the ΔR/R_{b} response of the detectors to the non-acidic analytes.

FIG. 4 is a PCA plot of normalized ΔRₘₐₓ/R_{b} responses for an array of plasticized l-PEI-carbon black detectors exposed to various volatile fatty acids. Each detector was exposed five times to each analyte, which was presented in a random order to the detector array. Key: + acetic acid; * propionic acid; · butyric acid; ° valeric acid; ▾ hexanoic acid.

FIG. 5A-B shows a graph of l-PEI-20% carbon black composite exposed to various partial pressures of methanol vapor. (A) Shows normalized mass uptake (Δmₘₐₓ/m_{b}) and normalized resistance response (ΔRₘₐₓ/R_{b}) of a l-PEI-carbon black film as a function of the partial pressure of methanol vapor in the air. (B) Shows normalized resistance change (ΔRₘₐₓ/R_{b}) as a function of normalized mass uptake as derived from the data presented in (A).

FIG. 6A-B shows clear l-PEI thin film exposed to various partial pressures of methanol vapor. (A) Normalized mass uptake (Δmₘₐₓ/m_{b}) and normalized thickness change (Δhₘₐₓ/h_{b}), as a function of the partial pressure of methanol vapor in air. (B) Normalized thickness change (Δhₘₐₓ/h_{b}) as a function of mass uptake (Δmₘₐₓ/m_{b}) of PEI film exposed to methanol vapor as derived from the data of (A).

FIG. 7A-B shows a plot of l-PEI-20% carbon black composite exposed to various partial pressures of acetic acid vapor. (A) Shows normalized mass uptake (Δmₘₐₓ/m_{b}) and normalized resistance change (ΔRₘₐₓ/R_{b}) of a l-PEI-carbon black film as a function of the partial pressure of acetic acid vapor in air. (B) Normalized resistance change (ΔRₘₐₓ/R_{b}) as a function of mass uptake as derived form the data of (A). Inset shows the behavior at low analyte absorption values.

FIG. 8A-B shows a plot of clear l-PEI thin film exposed to various partial pressures of acetic acid vapor. (A) Normalized mass uptake (Δmₘₐₓ/m_{b}) and thickness change (Δhₘₐₓ/h_{b}) of a clear l-PEI film as a function of the partial pressure of acetic acid vapor in air. (B) Thickness change (Δhₘₐₓ/h_{b}) of a l-PEI film as a function of the normalized mass uptake (Δmₘₐₓ/m_{b}) upon exposure to acetic acid vapor as derived from the data of (A).

FIG. 9A-B shows plots of analyte concentration in l-PEI films ([A]ₚ) vs. analyte concentration in vapor stream ([A]ᵥ) Values were obtained by using the ellipsometrically measured thickness data to obtain the volume of films at given mass uptake readings. (A) Exposure of an l-PEI film to various partial pressures of methanol vapor in air. Inset shows dK as a function of the concentration of methanol vapor in air. (B) Exposure of an l-PEI film to various partial pressures of acetic acid vapor in air.

FIG. 10A-B shows a plot of normalized thickness increase (Δhmax/h_{b}) vs. the relative resistance increase (ΔRmax/Rb) for clear l-PEI films and l-PEI-20% carbon black composites exposed to analyte vapor, as deduced from the data of FIGS. 4-7. (A) Films exposed to methanol vapor. (B) Films exposed to acetic acid vapor.

FIG. 11 is a plot of normalized resistance increase (ΔRₘₐₓ/R_{b}) upon exposure to acetic acid vapor of l-PEI films, containing varying amounts of carbon black filler (▴=l-PEI-10% carbon black composite; ⋄=l-PEI-20% carbon black composite; =l-PEI-30% carbon black composite).

FIG. 12 is a plot of normalized resistance increase (ΔRₘₐₓ/R_{b}) of l-PEI-carbon black films vs. volume of analyte sorbed (ml) per unit weight of l-PEI (g) (⋄=methanol; =acetic acid). The inset shows the data for low values of sorbed analyte volumes into the polymer films.

FIG. 13 shows a titration curve of an aqueous PEI solution with HCl(aq) solution (●), adapted from Suh et al. Bioorg. Chem, 25:221-231, 1997; and a titration curve of an aqueous n-butylamine solution with HCl(aq), as calculated form the Henderson-Hasselback equation (⋄).

FIG. 14 shows the relative resistance response (ΔRₘₐₓ/R_{b}) of a l-PEI-20% carbon black composite exposed to various P/P° acetic acid vapors along with expected ΔRₘₐₓ/R_{b} values calculated in the absence of percolation and charge-induced swelling effects. (⋄=observed response signal, ▴=responses expected without percolation effects, and ●=responses expected only due to mass uptake of analyte (no percolation or specific polymer-analyte interactions).

### DETAILED DESCRIPTION

The sensors and sensor arrays disclosed herein act as an “electronic nose” to offer ease of use, speed, and identification of analytes and/or analyte regions all in a portable, relatively inexpensive implementation. Thus, a wide variety of analytes and fluids may be analyzed by the disclosed sensors, arrays and noses so long as the subject analyte is capable generating a response when contacted with a sensor. Analyte applications include broad ranges of chemical classes such as organics including, for example, alkanes; alkenes; alkynes; dienes; alicyclic hydrocarbons; arenes; alcohols; ethers; ketones; aldehydes; carbonyls; carbanions; biogenic amines; thiols; polynuclear aromatics and derivatives of such organics, e.g., halide derivatives, and the like; biomolecules such as sugars; isoprenes and isoprenoids; and fatty acids and derivatives. Accordingly, commercial applications of the sensors, arrays and noses include environmental toxicology and remediation, biomedicine, materials quality control, food and agricultural products monitoring, anaesthetic detection, automobile oil or radiator fluid monitoring, breath alcohol analyzers, hazardous spill identification, explosives detection, fugitive emission identification, medical diagnostics, fish freshness, detection and classification of bacteria and microorganisms both in vitro and in vivo for biomedical uses and medical diagnostic uses, and the like. A wide variety of commercial applications are available for the sensors arrays and electronic noses including, but not limited to, heavy industrial manufacturing, ambient air monitoring, worker protection, emissions control, product quality testing, leak detection and identification, oil/gas petrochemical applications, combustible gas detection, H₂S monitoring, hazardous leak detection and identification, emergency response and law enforcement applications, illegal substance detection and identification, arson investigation, enclosed space surveying, utility and power applications, emissions monitoring, transformer fault detection, food/beverage/agriculture applications, freshness detection, fruit ripening control, fermentation process monitoring and control applications, flavor composition and identification, product quality and identification, refrigerant and fumigant detection, cosmetic/perfume/fragrance formulation, product quality testing, personal identification, chemical/plastics/pharmaceutical applications, leak detection, solvent recovery effectiveness, perimeter monitoring, product quality testing, hazardous waste site applications, fugitive emission detection and identification, leak detection and identification, perimeter monitoring, transportation, hazardous spill monitoring, refueling operations, shipping container inspection, diesel/gasoline/aviation fuel identification, building/residential natural gas detection, formaldehyde detection, smoke detection, fire detection, automatic ventilation control applications (cooking, smoking, etc.), air intake monitoring, hospital/medical anesthesia and sterilization gas detection, infectious disease detection and breath applications, body fluids analysis, pharmaceutical applications, drug discovery and telesurgery. Another application for the sensor-based fluid detection device in engine fluids is an oil/antifreeze monitor, engine diagnostics for air/fuel optimization, diesel fuel quality, volatile organic carbon measurement (VOC), fugitive gases in refineries, halitosis, soil and water contaminants, leak detection, fire safety, chemical weapons identification, use by hazardous material teams, explosive detection, breathalyzers, ethylene oxide detectors and anesthetics.

One specific class of analytes that is of interest is the straight chain volatile fatty acids, CₙH₂ₙ₊₁(COOH), 1<n<6. These acids are useful vapor biomarkers because they are by-products of the metabolic processes of certain bacteria. In addition, these fatty acids are released into the lungs and are expelled in the breath of humans having certain disease states. For example, volatile fatty acids are found on the breath of patients afflicted with larynx cancer and cirrhosis of the liver as well as in the vapor above vaginal tumors. Different types of bacteria have been documented to produce characteristic mixtures of volatile fatty acids, making differentiation between bacterial species possible by analysis of the volatile fatty acid composition in the headspace above bacterial cultures. The development of chemiresistive vapor detectors that are especially sensitive to volatile fatty acids would thus be of significant interest in that such materials should provide an enhanced capability to detect the presence of, as well as potentially classify and identify, various bacterial species and/or human disease states.

Thus, fatty acids and other related carboxylic acid containing compounds are biomarkers of bacteria, disease states, food freshness, and other odor-based conditions. The electronic nose sensor elements and arrays discussed herein incorporating an amine-containing material-conductor composites (e.g., linear polyethylenimine-carbon black) can be used to monitor the components in the headspace of urine, blood, sweat, breath and saliva of subjects, including human patients, to diagnose various states of health and disease. Sensor arrays comprising at least one sensor comprising an amine-containing material will provide improved performance in an unanticipated fashion through improvement in properties that combine sensor modalities. For example, surface acoustic wave (SAW) arrays, quartz crystal microbalance arrays, composites consisting of regions of conductors and regions of insulators, bulk semiconducting organic polymers, and other array types exhibit improved performance towards vapor discrimination and quantification when the amine-containing sensors described herein are incorporated into arrays that contain these other sensing modalities (e.g., wherein the array of sensors combines an amine-containing materials sensor with one or more of a metal oxide gas sensor, a conducting polymer sensor, a dye-impregnated polymer film on fiber optic detector, a polymer-coated micromirror, an electrochemical gas detector, a chemically sensitive field-effect transistor, a carbon black-polymer composite, a micro-electro-mechanical system device and a micro-opto-electro-mechanical system device).

Breath testing has long been recognized as a nonintrusive medical technique that might allow for the diagnosis of disease by linking specific volatile organic vapor metabolites (e.g., volatile fatty acids) in exhaled breath to medical conditions (see Table 1). For example, the production of volatile short chain fatty acids, such as butyric acid, are known risk factors for gingivitis. Organotrophs, for example, produce gas —CO2, H2, volatile fatty acids, and include mostly diplococci, some in chains. Many are paracitic or commensal. Other volatile fatty acids that can be detected include acetic, lactic, propionic, butyric, iso-butyric, valeric, iso-vakeric, and others.

In addition to breath analysis being nonintrusive, it offers several other potential advantages in certain instances, such as 1) breath samples are easy to obtain, 2) breath is in general a much less complicated mixture of components than either serum or urine samples, 3) direct information can be obtained on the respiratory function that is not readily obtainable by other means, and 4) breath analysis offers the potential for direct real time monitoring of the decay of toxic volatile substances in the body. Table 1 lists some of the volatile organic compounds that have been identified as targets for specific diseases using gas chromatography/mass spectrometry (GC/MS) methods.

TABLE 1

| Patient Diagnosis | Target VOCs | VOC Source |
|---|---|---|
| Uremia; Preti, 1992; | dimethylamine, | breath, urine |
| Simenhoff, 1977; | trimethylamine | |
| Davies, 1997 | | |
| Trimethylaminuria; | trimethylamine | breath, urine, swat, |
| Preti, 1992; Alwaiz, | | vaginal discharge |
| 1989 | | |
| Lung Cancer; Preti, 1992 | aniline, o-toluidine | lung air |
| Dysgeusia/Dysosmia; | hydrogen sulfide, methyl | lung air |
| Preti, 1992; Oneill, | mercaptn, pyridine, | |
| 1988 | aniline, diphenylamine, | |
| | dodecanol | |
| Cystinuria; Manolis A., | cadaverie, piperidine, | breath |
| 1983, Clin. Chem. 29: 5. | putrescine, pyrrolidine | |
| Halitosis; Kozlovsky, | hydrogen sulfide, methyl | mouth air |
| 1994; Preti, 1992 | mercaptan, cadaverine, | |
| | putrescine, indole, | |
| | skatole | |
| Bacterial Vaginosis; | amines | vaginal cavity and |
| Chandiok, 1997, J. | | discharge |
| Clinical Path., 50: 790. | | |

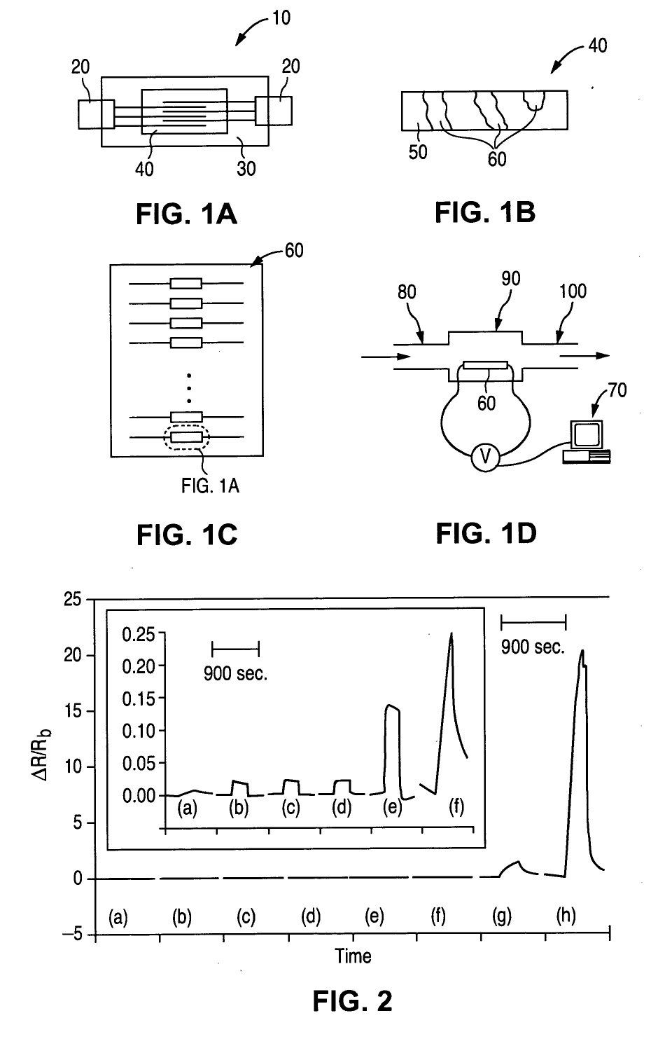

With reference now to the drawings, and particularly to FIG. 1A-D, there is shown a sensor and sensor array for detecting an analyte in a fluid for use in conjunction with an electrical measuring apparatus. FIG. 1A shows a sensor comprising conducitve leads 20 separated by a sensing area 40 such that the conductive leads are in contact with the sensing area. The sensing area 40 and conductive leads 20 may be disposed on a substrate 30. FIG. 1B shows the sensing are 40 in more detail. Sensing area 40 comprises regions of a conductive material 50 and regions of an amine-containing material 60. The regions 50 and 60 may be interpenetrating. FIG. 1C shows an array of sensors 60 as depicted in FIG. 1A. A sensor comprises regions of an amine-containing material and regions of a conductive material. The array comprises a plurality of differently responding chemical sensors, at least one of the sensors comprising an amine-containing material and a conductive material. For example, a sensor may be a chemiresistor comprising an amine-containing material and a conductive material disposed between and in electrical contact with two conductive leads such that the leads are separated by the amine-containing material-conductor composite. The leads may be any convenient conductive material, usually a metal, and may be interdigitized to maximize signal-to-noise strength (see FIG. 1A).

FIG. 1D shows a sensing system that comprises a vapor inlet 80 and outlet 100. Sensor array 60 is disposed within the vapor flow path and may be located within a flow chamber 90. The vapor flow path is generally depicted by the inlet and outlet arrows. A computer and/or measuring apparatus is generally depicted by refererence numeral 70. The computer and/or measuring appratus is capable of detecting changes in a sensor or sensor array when contacted with a vapor comprising an analyte.

A chemiresistor comprises a plurality of alternating regions of differing compositions and therefore differing conductivity transverse to the electrical path between the conductive leads. Generally, an array of sensors comprises at least one sensors fabricated by blending an amine-containing material with a conductive material (e.g., a conductive inorganic material, a conductive organic material, a conductive polymer, and the like). For example, in a colloid, suspension or dispersion of particulate conductive material in a region of an amine-containing material, the regions separating the particles provide changes in conductance relative to the conductance of the particles themselves. The gaps of different conductance arising from the amine-containing material range in path length from about 10 to 1,000 angstroms, usually on the order of 100 angstroms. The path length and resistance of a given gap is not constant but rather is believed to change as the material absorbs, adsorbs or imbibes an analyte. Accordingly the dynamic aggregate resistance provided by these gaps in a given resistor is a function of analyte permeation of the amine-containing material regions of the sensor. In some embodiments, the conductive material may also contribute to the dynamic aggregate resistance as a function of analyte permeation (e.g., when the conductive material is a conductive organic polymer such as polypyrrole and/or polyaniline and is blended with an amine-containing material to form the composite).

A wide variety of conductive materials and amine-containing materials can be used. For example, the conductive material can be comprised of an inorganic conductor (e.g., Au, Ag), organic conductor (e.g., carbon black), and/or an organic conducting polymer (e.g., polyaniline, polypyrrole, polythiophene, polyEDOT, and other conducting organic polymers such as those in the Handbook of Conducting Polymers (Handbook of Conducting Polymers, second ed., Marcel Dekker, New York 1997, vols. 1 & 2)). Other combinations of conductor/organic conductor and amine-containing composite materials are also useful.

Table 2 provides exemplary conductive materials for use in sensor fabrication; blends, such as of those listed, may also be used. Typically conductors include, for example, those having a positive temperature coefficient of resistance. The sensors are comprised of a plurality of alternating regions of a conductor with regions of an amine-containing material. Without being bound to any particular theory, it is believed that the electrical pathway that an electrical charge traverses between the two contacting electrodes traverses both the regions of the conductor and the regions of the organic material.

TABLE 2

| Major Class | Examples |
|---|---|
| Organic Conductors | conducting polymers (poly(anilines), |
| | poly(thiophenes), poly(pyrroles), |
| | poly(aceylenes, etc.)), carbonaceous |
| | material (carbon blacks, graphite, |
| | coke, C60 etc.), charge transfer |
| | complexes |
| | (tetramethylparaphenylenediamine- |
| | chloranile, alkali metal |
| | tetracyanoquinodimethane complexes, |
| | tetrathiofulvalene halide complexes, |
| | etc.), etc. |
| Inorganic Conductors | metals and metal alloys (Ag, Au, Cu, |
| | Pt, AuCu alloy, etc.), highly doped |
| | semiconductors (Si, GaAs, InP, MoS2, |
| | TiO2, etc.), conductive metal oxides |
| | (In2O3, SnO2, Na2Pt3O4, etc.), |
| | superconductors (Yba2Cu3O7, |
| | Ti2Ba2Ca2Cu3O10, etc.), etc. |
| Mixed inorganic/organic | Tetracyanoplatinate complexes, |
| Conductor | Iridium halocarbonyl complexes, |
| | stacked macrocyclic complexes. Etc. |

The conducting region can be anything that can carry electrons from atom to atom, including, but not limited to, a material, a particle, a metal, a polymer, a substrate, an ion, an alloy, an organic material (e.g., carbon, graphite, and the like), an inorganic material, a biomaterial, a solid, a liquid, a gas or regions thereof.

The conductive material can be a conductive particle, such as a colloidal nanoparticle. As used herein the term “nanoparticle” refers to a conductive cluster, such as a metal cluster, having a diameter on the nanometer scale. Such nanoparticles are optionally stabilized with organic ligands.

Examples of colloidal nanoparticles are described in the literature. An electrically conductive organic region can optionally be a ligand that is attached to a central core making up the nanoparticle. These ligands (e.g., caps) can be polyhomo- or polyhetero-functionalized, thereby being suitable for detecting a variety of chemical analytes. The nanoparticles can be stabilized by the attached ligands. In certain aspects, the conducting component of the resistors are nanoparticles comprising a central core conducting element and an attached ligand optionally in a polymer matrix. With reference to Table 2, various conducting materials are suitable for the central core. In certain aspects, the nanoparticles have a metal core. Such metal cores include, but are not limited to, Au, Ag, Pt, Pd, Cu, Ni, AuCu and the like. Gold (Au) is commonly used. These metallic nanoparticles can be synthesized using a variety of methods. In one method of synthesis, a modification of the protocol developed by Brust et al. can be used. (see, Brust et al., J. Chem. Soc., Chem. Commun., 1994, 801-802.) As explained more fully below, by varying the concentration of the synthetic reagents, the particle size can be manipulated and controlled.

Table 3 provides exemplary electrically conductive organic materials that can be used to form a conductive region of a sensor.

TABLE 3

| a | 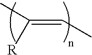 | R = alkyl, alkoxy |
|---|---|---|
| b | 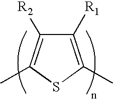 | R1 = H, alkyl, alkoxy R2 = H, alkyl,alkoxy |
| c | 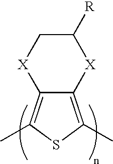 | X = S, O R = H, alkyl, alkoxy |
| d | 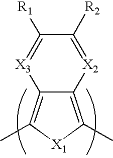 | X1 = S, O, N—H, N—R X2 = C, N X3 = C, N R1 = H, alkyl, alkoxy R2 = H, alkyl, alkoxy |
| e | 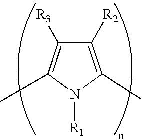 | R₁ = H, alkyl R2 = H, aklyl, alkoxy R3 = H, alkyl, alkoxy |
| f | 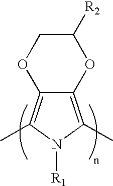 | R1 = H, alkyl R2 = H, alkyl, alkoxy |
| g | 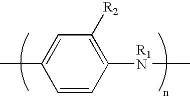 | R1 = H, alkyl, propanesulfonate R2 = H, alkyl, alkoxy, sulfonate |
| h | 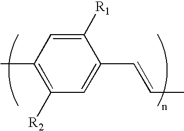 | R1 = H, alkyl, alkoxy R2 = H, alkyl, alkoxy |
| i | 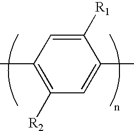 | R1 = alkyl, alkoxy R2 = alkyl, alkoxy |
| j | 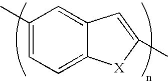 | X = S, O, N—H, N—R |
| k | 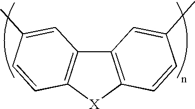 | X = S, O, N—H, N—R R = alkyl |
| l | 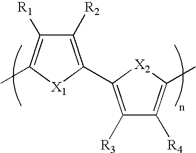 | X1 = S, O, N—H, N—R X2 = S, O, N—H, N—R R1 = H, alkyl, alkoxy R2 = H, alkyl, alkoxy R3 = H, alkyl, alkoxy R4 = H, alkyl, alkoxy R = alkyl |
| m | 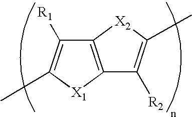 | X1 = S, O, N—H, N—R X2 = S, O, N—H, N—R |
| n | 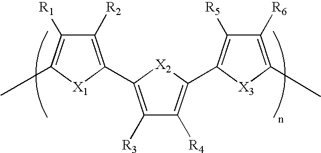 | X1 = S, O, N—H, N—R X2 = S, O, N—H, N—R X3 = S, O, N—H, N—R R = alkyl R1 = H, alkyl, alkoxy R2 = H, alkyl, alkoxy R3 = H, alkyl, alkoxy R4 = H, alkyl, alkoxy R5 = H, alkyl, alkoxy R6 = H, alkyl, alkoxy |
| o | 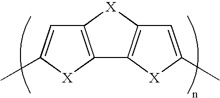 | X = S, O, N—H, N—R R = alkyl |
| p | 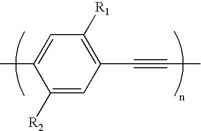 | R1 = H, alkyl, alkoxy R2 = H, alkyl, alkoxy |
| q | 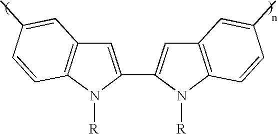 | R1 = H, alkyl |
| r | 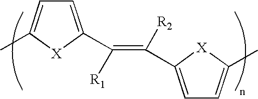 | X = S, O, N—H, N—R R1 = H, alkyl, alkoxy R2 = H, alkyl, alkoxy |
| s | 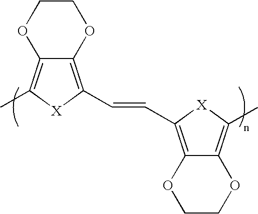 | X = S, O, N—H, N—R |
| t | 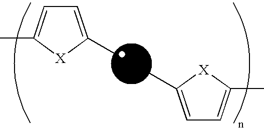 | 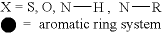 |
| u | 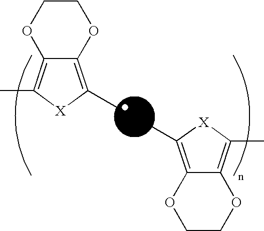 | 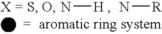 |
| v | 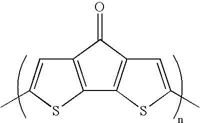 | |
| w | 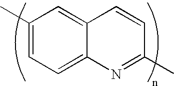 | |
| x | 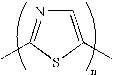 | |
| y | 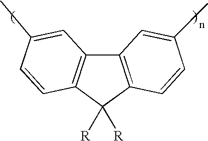 | R = H, alkyl, alkoxy |
| z | 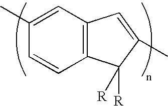 | R = H, alkyl, alkoxy |
| a. Poly (acetylene) and derivatives | | |
| b. Poly (thiophenes) and derivatives | | |
| c. Poly (3,4-ethylenedioxythiophene) and poly (3,4-ethylenedithiathiophene) and derivatives | | |
| d. Poly (isathianaphthene), poly(pyridothiophene), poly(pyrizinothiophene), and derivatives | | |
| e. Poly (pyrrole) and derivatives | | |
| f. Poly (3, 4-ethylenedioxypyrrole) and derivatives | | |
| g. Poly (aniline) and derivatives | | |
| h. Poly (phenylenevinylene) and derivatives | | |
| I. Poly (p-phenylene) and derivatives | | |
| j. Poly (thianapthene), poly (benxofuran), and poly (indole) and derivatives | | |
| k. Poly (dibenzothiophene), poly (dibenxofuran), and poly (carbazole) and derivatives | | |
| l. Poly (bithiophene), poly (bifuran), poly (bipyrrole), and derivatives | | |
| m. Poly (thienothiophene), poly(thienofuran), poly (thienopyrrole), poly (furanylpyrrole), poly (furanylfuran), poly (pyrolylpyrrole), and derivatives | | |
| n. Poly (terthiophene), poly (terfuran), poly (terpyrrole), and derivatives | | |
| o. Poly (dithienothiophene), poly (difuranylthiophene), poly (dipyrrolylthiophene), poly (dithienofuran), poly (dipyrrolylfuran), poly (dipyrrolylpyrrole) and derivatives | | |
| p. Poly (phenyl acetylene) and derivatives | | |
| q. Poly (biindole) and derivatives | | |
| r. Poly (dithienovinylene), poly (difuranylvinylene), poly (dipyrrolylvinylene) and derivatives | | |
| s. Poly (1,2-trans (3,4-ethylenedioxythienyl) vinylene), poly (1,2-trans (3,4-ethylenedioxyfuranyl) vinylene), and poly (1, 2-trans (3,4-ethylenedioxypyrrolyl) vinylene), and derivatives | | |
| t. The class of poly (bis-thienylarylenes) and poly (bis-pyrrolylarylenes) and derivatives | | |
| u. The class of poly (bis (3,4-ethylenedioxythienyl) arylenes) and derivatives | | |
| v. Poly (dithienylcyclopentenone) | | |
| w. Poly (quinoline) | | |
| x. Poly (thiazole) | | |
| y. Poly (fluorene) and derivatives | | |
| z. Poly (azulene) and derivatives | | |
| Notes: | | |
| a. Aromatics = phenyl, biphenyl, terphenyl, carbazole, furan, thiophene, pyrrole, fluorene, thiazole, pyridine, 2,3,5,6-hexafluorobenzene, anthracene, coronene, indole, biindole, 3,4-ethylenedioxythiophene, 3,4-ethylenedioxypyrrole, and both the alkyl and alkoxy derivatives of these aromatics. | | |
| b. Alkyl = aliphatic group branched or straight chain ranging from CH₃ to C₂₀H₄₁. | | |
| c. Alkoxy = OR, where R is an aliphatic group that may either be branched or straight chain ranging from CH₃ to C₂₀H₄₁. | | |
| d. All conductive polymers are depicted in their neutral, nonconductive form. The polymers listed in the figure are doped oxidatively either by means chemically or electrochemically. | | |
| e. The class of polyanilines are acid doped and can be done so with a number of sulfonic acids including methane sulfonic acid, ethane sulfonic acid, propane sulfonic acid, butane sulfonic acid, pentane sulfonic acid, hexane sulfonic acid, heptane sulfonic acid, octane sulfonic acid, nonane sulfonic acid, decane sulfonic acid, ondecane sulfonic acid, dodecane sulfonic acid, dodecylbenzenesulfonic acid, toluene sulfonic acid, benzene sulfonic acid, dinonanylnaphthalene | | |
| # sulfonic acid, and both the d and l forms of camphor sulfonic acid. | | |

f. All other class of conductive polymers when doped there is an associated counter ion to compensate the positive charges on the backbone. These can be perchlorate, hexafluorophosphate, tetrafluoroborate, fluoride, chloride, bromide, iodide, triflate, etc.

The conductive material can be selected from the group consisting of an inorganic conductor, an organic semiconductor and an organic conductor. “Semi-conductors” as used herein, include materials whose electrical conductivity increases as the temperature increases, whereas conductors are materials whose electrical conductivity decreases as the temperature increases. By this fundamental definition, the organic materials that are useful in the sensors are either semiconductors or conductors. Such materials are collectively referred to herein as conducting organic materials because they produce a readily-measured resistance between two conducting leads separated by about 10 micron or more using readily-purchased multimeters having resistance measurement limits of 100 Mohm or less, and thus allow the passage of electrical current through them when used as elements in an electronic circuit at room temperature. Semi-conductors and conductors can be differentiated from insulators by their different room temperature electrical conductivity values. Insulator show very low room temperature conductivity values, typically less than about 10⁻⁸ ohm⁻¹ cm⁻¹. Poly(styrene), poly(ethylene), and other polymers elaborated in Table 4 provide examples of insulating organic materials. Metals have very high room temperature conductivities, typically greater than about 10 ohm⁻¹ cm⁻¹. Semi-conductors have conductivities greater than those of insulators, and are distinguished from metals by their different temperature dependence of conductivity, as described above. Examples of semiconducting and conducting organic material are provided in Table 3. The conductive materials that are useful in the sensors are semiconductors or conductors, and have room temperature electrical conductivities of greater than about 10⁻⁶ ohm⁻¹ cm⁻¹, but more typically will have a conductivity of greater than about 10⁻³ ohm⁻¹ cm⁻¹.

Various amine containing materials can be used in the methods and compositions of the invention including, but not limited to, polyimines, polyallylamine, polyvinylamine, polyhistidine, polyomithine, polylysine, and polyarginine. Examples of polyimine materials useful in the sensors described herein include poly(acetyliminoethylene), polyethylenimine, and poly(valeryl-iminoethylene). Poly(ethylenimine) sometimes referred to as poly (iminoethylene), poly(imino(1,2-ethanediyl)), and corcat is further described below as exemplary of the polyimines useful in the sensors and sensor arrays described herein. Other amine-containing polymers include poly(1-vinylimidazole), poly(4-vinylpyridine), poly(styrene-co-N-benzyl-N,N-dimethyl-N-vinylbenzyl-ammonium chloride-co-divinylbenzene) (49:49:2 mole ratio), poly(N,N,N-tributyl-N-vinylbenzyl-ammonium chloride), poly(N,N-dimethyl-N-benzyl-N-vinylbenzyl-ammonium chloride), poly(styrene-co-N,N,N-trimethyl-N-vinylbenzyl-ammonium chloride) (1:1 mole ratio), poly(N,N,N-trimethyl-N-vinylbenzyl-ammonium chloride-co-divinylbenzene) (87:13 mole ratio), poly(N,N-dimethyl-N-octadecyl-N-vinylbenzyl-ammonium chloride), poly(styrene-co-1-vinylimidazole-co-3-hydroxyethyl-1-vinylimidazolium chloride) (5:4:1 mole ratio), poly(styrene-co-1-vinylimidazole-co-3-benzyl-1-vinylimidazolium chloride) (5:4:1 mole ratio), poly(styrene-co-1-vinylimidazole-co-3-hydroxyethyl-1-vinylimidazolium chloride) (2:2:1 mole ratio), poly(styrene-co-4-vinylpyridine-co-1-hydroxyethyl-4-vinylpyridinium chloride) (5:4:1 mole ratio), and poly(diallydimethylammonium chloride).

As discussed above, a sensor comprises regions of an amine-containing material and a conductive material. Linear, branched and crosslinked poly(ethylenimine) can be used in the sensors. Poly(ethylenimine) can be prepared as follows. Poly(2-ethyl-2-oxazoline) with an average molecular weight of about 500,000 g/mole is obtained from Aldrich Chemical Co., Milwaukee, Wis. The poly(2-ethyl-2-oxazoline) is dissolved in a hydrochloric acid solution. The solution is refluxed at 100° C. for 72 hours then allowed to cool to room temperature. Product is precipitated from the reaction solution by with a 50% solution of sodium hydroxide dropwise while stirring. The white solid precipitate is recovered by vacuum filtration and washed with water. The product is dried to yield linear poly(ethylenimine). Linear polyethylenimine can be crosslinked (if desired) by dissolving the linear poly(ethylenimine) in 50 mL of methanol. Ethylene glycol diglycidyl ether (50% soln.), about 0.5 grams, is added to the linear polyethylenimine solution and the mixture is stirred at room temperature for about two minutes before being placed in a vented oven at about 65° C. for three hours. The resultant gel is disrupted to yield sizes of about 5 mm in diameter, and stirred gently in 500 mL of methanol overnight. The sample is recovered by decantation, and is dried to yield a lightly crosslinked polyethylenimine polymer.

Accordingly, the sensors comprise regions of an electrical conductor and regions of an amine-containing material (such as linear polyethylenimine). As used above, electrical conductive materials include, for example, Au, Ag, Pt, carbon black, polypyrrole, polyaniline, polythiophene, and the like, other conductive materials having similar resistivity profiles are easily identified in the art (see, for example the latest edition of: The CRC Handbook of Chemistry and Physics, CRC Press, the disclosure of which is incorporated herein by reference). Furthermore, insulators can also be incorporated into the composite to further manipulate the analyte response properties of the composites. The additional insulating region (i.e., non-conductive region) can be anything that can impede electron flow from atom to atom, including, but not limited to, a material, a polymer, a plasticizer, an organic material, an organic polymer, a filler, a ligand, an inorganic material, a biomaterial, a solid, a liquid, a gas and regions thereof. Table 4 provides examples of insulating organic materials that can be used for such purposes.

TABLE 4

| Major Class | Examples |
|---|---|
| Main-chain carbon polymers | poly(dienes), poly(alkenes), |
| | poly(acrylics), poly(methacrylics), |
| | poly(vinyl ethers), poly(vinyl |
| | thioethers), poly(vinyl alcohols), |
| | poly(vinyl ketones), poly(vinyl |
| | halides), poly(vinyl nitrites), |
| | poly(vinyl esters), poly(styrenes), |
| | poly(aryines), etc. |
| Main-chain acyclic heteroatom | poly(oxides), poly(caronates), |
| polymers | poly(esters), poly(anhydrides), |
| | poly(urethanes), poly(sulfonate), |
| | poly(siloxanes), poly(sulfides), |
| | poly(thioesters), poly(sulfones), |
| | poly(sulfonamindes), poly(amides), |
| | poly(ureas), poly(phosphazens), |
| | poly(silanes), poly(silazanes), etc. |
| Main-chain heterocyclic polymers | poly(furantetracarboxylic acid |
| | diimides), poly(benzoxazoles), |
| | poly(oxadiazoles), |
| | poly(benzothiazinophenothiazines), |
| | poly(benzothiazoles), |
| | poly(pyrazinoquinoxalines), |
| | poly(pyromenitimides), |
| | poly(quinoxalines), |
| | poly(benzimidazoles), |
| | poly(oxidoles), |
| | poly(oxoisinodolines), |
| | poly(diaxoisoindoines), |
| | poly(triazines), poly(pyridzaines), |
| | poly(pioeraziness), |
| | poly(pyridinees), poly(pioeridiens), |
| | poly(triazoles), poly(pyrazoles), |
| | poly(pyrrolidines), |
| | poly(carboranes), |
| | poly(oxabicyclononanes), |
| | poly(diabenzofurans), |
| | poly(phthalides), poly(acetals), |
| | poly(anhydrides), carbohydrates, |
| | etc. |

Nonconductive organic polymer materials; blends and copolymers; plasticized polymers; and other variations including those using the polymers listed here, may also be used. Combinations, concentrations, blend stoichiometries, percolation thresholds, and the like are readily determined empirically by fabricating and screening prototype resistors (chemiresistors) as described below.

The chemiresistors can be fabricated by many techniques such as, but not limited to, solution casting, suspension casting, and mechanical mixing. In general, solution cast routes are advantageous because they provide homogeneous structures and ease of processing. With solution cast routes, sensor elements may be easily fabricated by spin, spray or dip coating. Since all elements of the sensor film must be soluble, however, solution cast routes are somewhat limited in their applicability. Suspension casting still provides the possibility of spin, spray or dip coating but more heterogeneous structures than with solution casting are expected. With mechanical mixing, there are no solubility restrictions since it involves only the physical mixing of the conductive and non-conductive components, but device fabrication is more difficult since spin, spray and dip coating are no longer possible. A more detailed discussion of each of these follows.

For systems where both the conducting, amine-containing material and non-conducting material or their reaction precursors are soluble in a common solvent, the chemiresistors can be fabricated by solution casting. In this reaction, the phosphomolybdic acid and pyrrole are dissolved in tetrahydrofuran (THF) and polymerization occurs upon solvent evaporation. This allows for THF soluble amine-containing materials, semiconductive, and non-conductive materials to be dissolved into this reaction region thereby allowing the composite to be formed in a single step upon solvent evaporation. The choice of an amine-containing material and a conductive material in this route is, of course, subject to those that are soluble in the reaction media.

A variety of permutations on this scheme are possible. Some of these are listed below. Certain conducting organic polymers, such as substituted poly-(cyclooctatetraenes), are soluble in their undoped, non-conducting state in solvents such as THF or acetonitrile. Consequently, the blends between the undoped polymer and other materials can be formed from solution casting. After which, the doping procedure (exposure to I₂ vapor, for instance) can be performed on the blend to render the substituted poly(cyclooctatetraene) conductive. Again, the choice of an amine-containing material is subject to those that are soluble in the solvents that the undoped conducting polymer is soluble in and to those stable to the doping reaction.

In suspension casting, one or more of the components of the sensor is suspended and the others dissolved in a common solvent. Suspension casting is a rather general technique applicable to a wide range of species, such as carbon blacks or colloidal metals, which can be suspended in solvents by vigorous mixing or sonication. In one application of suspension casting, the amine-containing material is dissolved in an appropriate solvent (such as THF, acetonitrile, water, or the like). Carbon black is then suspended in this solution and used to dip coat or spray coat electrodes.

Mechanical mixing is suitable for all of the conductive/conductive organic/non-conductive combinations possible. In this technique, the materials are physically mixed in a ball-mill or other mixing device. For example, carbon black-polyimine composites are readily made by ball-milling. When the materials can be melted or significantly softened without decomposition, mechanical mixing at elevated temperature can improve the mixing process. Alternatively, composite fabrication can sometimes be improved by several sequential heat and mix steps.

Once fabricated, the individual sensors can be optimized for a particular application by varying their chemical make up and morphologies. The chemical nature of the sensors determines to which analytes they will respond and their ability to distinguish different analytes. The relative ratio of conductive to amine-containing material (e.g. polyimine), along with the composition of any other material (e.g., other insulating organic or inorganic components), can determine the magnitude of the response since the resistance of the elements becomes more sensitive to sorbed molecules as the percolation threshold is approached and as the molecules interact chemically with the components of the composite that adsorb or absorb the analyte. The film morphology is also important in determining response characteristics. For instance, uniform thin films respond more quickly to analytes than do uniform thick ones. Hence, with an empirical catalogue of information on chemically diverse sensors made with varying ratios of semiconductive, conducting, and insulating components and by differing fabrication routes, sensors can be chosen that are appropriate for the analytes expected in a particular application, their concentrations, and the desired response times. Sensors comprising varied thicknesses may be purposefully designed. The varying thickness of compositionally identical sensors provide information on the diffusion times, for example, of an analyte. In certain aspects the thickness variation may be between sensors or variations within a sensor (e.g., variations in polyimine thickness in a sensor). Further optimization can then be performed in an iterative fashion as feedback on the performance of an array under particular conditions becomes available.

The resistor may itself form a substrate for attaching the lead or the resistor. For example, the structural rigidity of the resistors may be enhanced through a variety of techniques: chemical or radiation cross-linking of polymer components (dicumyl peroxide radical cross-linking, UV-radiation cross-linking of poly(olefins), sulfur cross-linking of rubbers, e-beam cross-linking of Nylon, etc.), the incorporation of polymers or other materials into the resistors to enhance physical properties (for instance, the incorporation of a high molecular weight, high melting temperature (Tₘ) polymers), the incorporation of the resistor elements into supporting matrices such as clays or polymer networks (forming the resistor blends within poly-(methylmethacrylate) networks or within the lamellae of montmorillonite, for instance). The resistor can be deposited as a surface layer on a solid matrix that provides means for supporting the leads. Typically, the matrix is a chemically inert, non-conductive substrate such as a glass or ceramic.

Sensor arrays particularly well-suited to scaled up production are fabricated using integrated circuit (IC) design technologies. For example, the chemiresistors can easily be integrated onto the front end of a simple amplifier interfaced to an A/D converter to efficiently feed the data stream directly into a neural network software or hardware analysis section. Micro-fabrication techniques can integrate the chemiresistors directly onto a micro-chip that contains the circuitry for analog signal conditioning/processing and then data analysis. This provides for the production of millions of incrementally different sensor elements in a single manufacturing step using ink-jet technology. Controlled compositional gradients in the chemiresistor elements of a sensor array can be induced in a method analogous to how a color ink-jet printer deposits and mixes multiple colors. However, in this case rather than multiple colors, a plurality of different amine-containing materials and conducting materials are suspended or dissolved in solution which can then be applied to a substrate. A sensor array of a million distinct elements only requires a 1 cm×1 cm sized chip employing lithography at the 10 micrometer feature level, which is within the capacity of conventional commercial processing and deposition methods. This technology permits the production of sensitive, small-sized, stand-alone chemical sensors.

The sensor arrays can have a predetermined inter-sensor variation in the structure or composition of the amine-containing material and conductive or semiconductive organic materials, as well as in the conductive components and any insulating or plastizing components of the composites. The variation may be quantitative and/or qualitative. For example, the concentration of the polyimine or species of polyimine in the composite can be varied across sensors. The ability to fabricate many chemically different materials allows ready incorporation of a wide range of chemical diversity into the sensor elements, and also allows facile control over the electrical properties of the sensor elements through control over the composition of an, individual sensor element in the array. The addition of non-amine-containing materials can be used and blended into a sensor or sensor array in order to further increase diversity. When insulators are added, commercial, off-the-shelf, organic polymers can provide the basic sensor components that respond differently to different analytes, based on the differences in polarity, molecular size, and other properties of the analyte in order to achieve the chemical diversity amongst array elements in the electronic nose sensors. Such insulators would include main-chain carbon polymers, main chain acyclic heteroatom polymers, main-chain heterocyclic polymers, and other insulating organic materials. Other modifications in sensor properties can be obtained by modification of an electrically conductive or electrically semiconductive organic component of a sensor composition by use of capping agents on a colloidal metal part of the conductive phase, by use of different plasticizers added to otherwise compositionally identical sensor elements to manipulate their analyte sorption and response properties, by variation in the temperature or measurement frequency of the sensors in an array of sensors that are otherwise compositionally identical, or a combination thereof. The sensors in an array can readily be made by combinatorial methods in which a limited number of feedstocks is combined to produce a large number of chemically distinct sensor elements.

One method of enhancing the diversity of polymer based amine-containing material/conductor or amine-containing material/semiconductor-polymer chemiresistors is through the use of polymer blends or copolymers (Doleman, et al. (1998) Anal. Chem. 70, 2560-2654). Immiscible polymer blends may also be of interest because carbon black or other conductors can be observed to preferentially segregate into one of the blend components. Such a distribution of carbon black conduction pathways may result in valuable effects upon analyte sorption, such as the observance of a double percolation threshold. Binary polymer blend sensors can be prepared from a variety of polymers at incrementally different blend stoichiometries. Instead of manually fabricating twenty blends of varying composition, a spray gun with dual controlled-flow feedstocks could be used to deposit a graded-composition polymer film across a series of electrodes. Such automated procedures allow extension of the sensor compositions beyond simple binary blends, thereby providing the opportunity to fabricate chemiresistors with sorption properties incrementally varied over a wide range. In the fabrication of many-component blends, a combinatorial approach aided by microjet fabrication technology is one approach that will be known to those skilled in the art. For instance, a continuous jet fed by five separate feedstocks can fabricate numerous polymer blends in a combinatorial fashion on substrates with appropriately patterned sets of electrodes. Multiple nozzle drop-on-demand systems (multiple nozzle continuous jet systems are not as prevalent because of their greater complexity) may also be used. In this approach, each nozzle would be fed with a different polymer/amine-containing material, each dissolved in a common solvent. In this manner, a large number of combinations of 10-20 polymers can be readily fabricated.

The resistors can include nanoparticles comprising a central core conducting element and an attached ligand, with these nanoparticles dispersed in a semiconducting or conducting matrix. With reference to Table 2, various conducting materials are suitable for the central core. In certain embodiments, the nanoparticles have a metal core. Examples of metal cores include, but are not limited to, Au, Ag, Pt, Pd, Cu, Ni, AuCu and combinations thereof. These metallic nanoparticles can be synthesized using a variety of methods. In one method of synthesis, a modification of the protocol developed by Brust et al. (the teachings of which are incorporated herein by reference), can be used. Using alkanethiolate gold clusters as an illustrative example, the starting molar ratio of HAuCl₄ to alkanethiol is selected to construct particles of the desired diameter. The organic phase reduction of HAuCl₄ by an alkanethiol and sodium borohydride leads to stable, modestly polydisperse, alkanethiolate-protected gold clusters having a core dimension of about 1 nm to about 100 nm. The nanoparticles range in size from about 1 nm to about 50 nm, but may also range in size from about 5 nm to about 20 nm.

In this reaction, a molar ratio of HAuCl₄ to alkanethiol of greater than 1:1 leads to smaller particle sizes, whereas a molar ratio of HAuCl₄ to alkanethiol less than 1:1 yield clusters which are larger in size. Thus, by varying the ratio of HAuCl4 to alkanethiol, it is possible to generate various sizes and dimensions of nanoparticles suitable for a variety of analytes. Although not intending to be bound by any particular theory, it is believed that during the chemical reaction, as neutral gold particles begin to nucleate and grow, the size of the central core is retarded by the ligand monolayer in a controlled fashion. Using this reaction, it is then possible to generate nanoparticles of exacting sizes and dimensions.

In certain other embodiments, sensors are prepared as composites of “naked” nanoparticles and an amine-containing material (other conductive or insulating materials may be added to increase diversity of the sensor). As used herein, the term “naked nanoparticles” means that the core has no covalently attached ligands or caps. Suitable amine-containing materials include, but are not limited to, polyimine, polyallylamine, polyvinylamine, polyhistidine, polyomithine, polylysine, polyarginine, poly(acetyliminoethylene), poly ethylenimine, and poly(valeryl-iminoethylene), and derivatives thereof as well as others mentioned herein. In one embodiment, the conductor to amine-containing material ratio is about 50% to about 90% (wt/wt).

Sensor arrays allow expanded utility because the signal for an imperfect “key” in one channel can be recognized through information gathered on another, chemically or physically dissimilar channel in the array. A distinct pattern of responses produced over the collection of sensors in the array can provide a fingerprint that allows classification and identification of the analyte, whereas such information would not have been obtainable by relying on the signals arising solely from a single sensor or sensing material.

The general method for using the disclosed sensors, arrays and noses, for detecting the presence of an analyte in a fluid, where the fluid is a liquid or a gas, involves sensing the presence of an analyte in a fluid with a sensor. In one aspect, the sensor comprises regions of an amine-containing material that is capable of interacting with a vapor analyte resulting in a change in the physical and/or chemical properties of the sensor, wherein such changes can be detected by a measuring apparatus. For example, such sensors include chemiresistors, acoustic resonance sensors and the like. In another aspect, the sensor comprises first and second conductive leads electrically coupled to and separated by a chemically sensitive resistor comprising regions of an amine-containing material and regions of a conductive material (as described above) by measuring a first resistance between the conductive leads when the resistor is contacted with a first fluid comprising first analyte and a second, different resistance when the resistor is contacted with a second, different fluid.

An ideal detector array would produce a unique signature for every different analyte to which it was exposed. To construct such a system, detectors that probe important, but possibly subtle, molecular parameters such as chirality should be included. The term “chiral” is used herein to refer to an optically active or enantiomerically pure compound, or to a compound containing one or more asymmetric centers in a well-defined optically active configuration. A chiral compound is not superimposable upon its mirror image. Harnessing enantiomer resolution gives rise to myriad applications. For instance, because the active sites of enzymes are chiral, only the correct enantiomer is recognized as a substrate. Thus, pharmaceuticals having near enantiomeric purity are often many more times active than their racemic mixtures. However, many pharmaceutical formulations marketed today are racemic regions of the desired compound and its “mirror image.” One optical form (or enantiomer) of a racemic region may be medicinally useful, while the other optical form may be inert or even harmful, as has been reported to be the case for thalidomide. Chiral sensor elements could be part of a larger detector array that included non-chiral elements, thus broadening the discrimination ability of such arrays towards chiral analytes. Suitable chiral resolving agents include, but are not limited to, chiral molecules, such as chiral polymers; natural products, such as, tartaric, malic and mandelic acids; alkaloids, such as brucine, strychnine, morphine and quinine; lanthanide shift reagents; chelating agents; biomolecules, such as proteins, cellulose and enzymes; and chiral crown ethers together with cyclodextrins. (see, E. Gassmann et al., “Electrokinetic Separation of Chiral Compounds,” Science, vol. 230, pp. 813-814 (1985); and R. Kuhn et al., “Chiral Separation by Capillary Electrophoresis,” Chromatographia, vol. 34, pp. 505-512 (1992)). Additional chiral resolving agents suitable for use will be known by those of skill in the art. In this fashion, the sensors and sensor arrays would be useful in assessing which form of chirality, and of what enantiomeric excess, was present in an analyte in a fluid. Due to the presence of chiral moieties, many biomolecules, such as amino acids, are amenable to detection using the sensor arrays.

Plasticizers can also be used to obtain improved mechanical, structural, and sorption properties of the sensing films. Suitable plasticizers for use include, but are not limited to, phthalates and their esters, adipate and sebacate esters, polyols such as polyethylene glycol and their derivatives, tricresyl phosphate, castor oil, camphor and the like. Those of skill in the art will be aware of other plasticizers suitable for use.

In another embodiment, the sensor for detecting the presence of a chemical analyte in a fluid comprises a chemically sensitive resistor electrically connected to an electrical measuring apparatus where the resistor is in thermal communication with a temperature control apparatus. As described above, the chemically sensitive resistor(s) comprise regions of an amine-containing material and regions of a conductive material. The chemically sensitive resistor provides an electrical path through which electrical current may flow at a resistance (R) at a temperature (T) when contacted with a fluid comprising a chemical analyte.

In operation, the chemically sensitive resistor(s)/sensor(s) for detecting the presence of a chemical analyte in a fluid provides an electrical resistance (Rₘ) when contacted with a fluid comprising a chemical analyte at a particular temperature (Tₘ). The electrical resistance observed may vary as the temperature varies, thereby allowing one to define a unique profile of electrical resistances at various different temperatures for any chemical analyte of interest. For example, a chemically sensitive resistor, when contacted with a fluid comprising a chemical analyte of interest, may provide an electrical resistance Rₘ at temperature Tₘ where m is an integer greater than 1, and may provide a different electrical resistance Rₙ at a different temperature Tₙ. The difference between Rₘ and Rₙ is readily detectable by an electrical measuring apparatus.

As such, the chemically sensitive resistor(s)/sensor(s) are in thermal communication with a temperature control apparatus, thereby allowing one to vary the temperature at which electrical resistances are measured. If the sensor comprises an array of two or more chemically sensitive resistors each being in thermal communication with a temperature control apparatus, one may vary the temperature across the entire array, thereby allowing electrical resistances to be measured simultaneously at various different temperatures and for various different resistor compositions. For example, in an array of chemically sensitive resistors, one may vary the composition of the resistors in the horizontal direction across the array, such that resistor composition in the vertical direction across the array remains constant. One may then create a temperature gradient in the vertical direction across the array, thereby allowing the simultaneous analysis of chemical analytes at different resistor compositions and different temperatures.

Methods for placing chemically sensitive resistors in thermal communication with a temperature control apparatus are readily apparent to those skilled in the art and include, for example, attaching a heating or cooling element to the sensor and passing electrical current through said heating or cooling element. The temperature range across which electrical resistances may be measured will be a function of the resistor composition, for example the melting temperature of the resistor components, the thermal stability of the analyte of interest or any other component of the system, and the like. For the most part, the temperature range across which electrical resistance will be measured will be about 10° C. to 80° C. (e.g., about 22° C. to about 70° C. or about 20° C. to 65° C.).

In yet another embodiment, rather than subjecting the sensor to a direct electrical current and measuring the true electrical resistance through the chemically sensitive resistor(s), the sensor can be subjected to an alternating electrical current at different frequencies to measure impedance. Impedance is the apparent resistance in an alternating electrical current as compared to the true electrical resistance in a direct current. A sensor for detecting the presence of a chemical analyte in a fluid can comprise a chemically sensitive resistor electrically connected to an electrical measuring apparatus, the chemically sensitive resistor comprising regions of an amine-containing material and regions of a conductive material, wherein said resistor provides (a) an electrical path through the region of an amine-containing material and the conductive material, and (b) an electrical impedance Zₘ at frequency θₘ when contacted with a fluid comprising a chemical analyte, where m is an integer greater than 1 and θₘ does not equal 0. For measuring impedance as a function of frequency, the frequencies employed will generally range from about 1 Hz to 5 GHz, usually from about 1 MHz to 1 GHz, more usually from about 1 MHz to 10 MHz. Chemical analytes of interest will exhibit unique impedance characteristics at varying alternating current frequencies. Thereby allowing one to detect the presence of any chemical analyte of interest in a fluid by measuring Zₘ at alternating frequency θₘ.

For performing impedance measurements, one may employ virtually any impedance analyzer known in the art. For example, a Schlumberger Model 1260 Impedance/Gain-Phase Analyzer (Schlumberger Technologies, Farmborough, Hampshire, England) with approximately 6 inch RG174 coaxial cables is employed. In such an apparatus, the resistor/sensor is held in an Al chassis box to shield it from external electronic noise.

In still another embodiment, one may vary both the frequency θₘ of the electrical current employed and the temperature Tₙ and measure the electrical impedance Z_{m,n}, thereby allowing for the detection of the presence of a chemical analyte of interest. As such, the disclosure is also directed to a sensor for detecting the presence of a chemical analyte in a fluid, said sensor comprising a chemically sensitive resistor electrically connected to an electrical measuring apparatus and being in thermal communication with a temperature control apparatus, the chemically sensitive resistor comprising regions of an amine-containing material and regions of a conductive material, wherein the resistor provides (1) an electrical path through the region of amine-containing material and the conductive material, and (2) an electrical impedance Z_{m,n} at frequency θₘ and temperature Tₙ when contacted with a fluid comprising the chemical analyte, where m and/or n is an integer greater than 1. For measuring impedance as a function of frequency and temperature, the frequencies employed will generally not be higher than 10 MHz, by typically not higher than 5 MHz. Chemical analytes of interest will exhibit unique impedance characteristics at varying alternating current frequencies and varying temperatures, thereby allowing one to detect the presence of any chemical analyte of interest in a fluid by measuring Z_{m,n} at frequency θₘ and temperature Tₙ.

In another aspect, one particular sensor composition can be used in an array (i.e., all sensors in the array are compositionally identical) and the response properties can be varied by maintaining each sensor at a different temperature from at least one of the other sensors, or by performing the electrical impedance measurement at a different frequency for each sensor, or a combination thereof.

An electronic nose for detecting an analyte in a fluid is fabricated by coupling sensor leads of an array of different sensors to a measuring device. The device measures changes in signal at each sensor of the array, typically simultaneously and usually over time. The signal can be an electrical resistance, although it could also be an impedance or other physical property of the material in response to the presence of the analyte in the fluid. Frequently, the device includes signal processing means and is used in conjunction with a computer and data structure for comparing a given response profile to a structure-response profile database for qualitative and quantitative analysis. Typically such a nose comprises usually at least ten, often at least 100, and perhaps at least 1000 different sensors though with mass deposition fabrication techniques described herein or otherwise known in the art, arrays of on the order of at least one million sensors are readily produced.

In one mode of operation with an array of sensors, each resistor provides a first electrical resistance between its conductive leads when the resistor is contacted with a first fluid comprising a first analyte, and a second electrical resistance between its conductive leads when the resistor is contacted with a second fluid comprising a second, different analyte. The fluids may be liquid or gaseous in nature. The first and second fluids may reflect samples from (1) two different environments, (2) a change in the concentration of an analyte in a fluid sampled at two time points, (3) a sample and a negative control, and the like. The sensor array comprises sensors that respond differently to a change in an analyte concentration or identity between the first and second electrical resistance.

In one embodiment, the temporal response of each sensor (resistance as a function of time) is recorded. The temporal response of each sensor may be normalized to a maximum percent increase and percent decrease in signal that produces a response pattern associated with the exposure of the analyte. By iterative profiling of known analytes, a structure-function database correlating analytes and response profiles is generated. Unknown analytes may then be characterized or identified using response pattern comparison and recognition algorithms. Accordingly, analyte detection systems comprising sensor arrays, an electrical measuring device for detecting resistance across each chemiresistor, a computer, a data structure of sensor array response profiles, and a comparison algorithm are provided. In another embodiment, the electrical measuring device is an integrated circuit comprising neural network-based hardware and a digital-analog converter (DAC) multiplexed to each sensor, or a plurality of DACs, each connected to different sensor(s).

The desired signals if monitored as dc electrical resistances for the various sensor elements in an array can be read merely by imposing a constant current source through the resistors and then monitoring the voltage across each resistor through use of a commercial multiplexable 20 bit analog-to-digital converter. Such signals are readily stored in a computer that contains a resident algorithm for data analysis and archiving. Signals can also be preprocessed either in digital or analog form; the latter might adopt a resistive grid configuration, for example, to achieve local gain control. In addition, long time adaptation electronics can be added or the data can be processed digitally after it is collected from the sensors themselves. This processing could be on the same chip as the sensors but also could reside on a physically separate chip or computer.

Data analysis can be performed using standard chemometric methods such as principal component analysis and SIMCA, which are available in commercial software packages that run on a PC or which are easily transferred into a computer running a resident algorithm or onto a signal analysis chip either integrated onto, or working in conjunction with, the sensor measurement electronics. The Fisher linear discriminant is one algorithm for analysis of the data, as described below. In addition, more sophisticated algorithms and supervised or unsupervised neural network based learning/training methods can be applied as well (Duda and Hart, Pattern Classification and Scene Analysis; John Wiley & Sons: New York, 1973, pp 482).

The signals can also be useful in forming a digitally transmittable representation of an analyte in a fluid. Such signals could be transmitted over the Internet in encrypted or in publicly available form and analyzed by a central processing unit at a remote site, and/or archived for compilation of a data set that could be mined to determine, for example, changes with respect to historical mean “normal” values of the breathing air in confined spaces, of human breath profiles, and of a variety of other long term monitoring situations where detection of analytes in fluids is an important value-added component of the data.

Twenty to thirty different sensors is sufficient for many analyte classification tasks but larger array sizes can be implemented as well. Temperature and humidity can be controlled but because a one mode is to record changes relative to the ambient baseline condition, and because the patterns for a particular type and concentration of odorant are generally independent of such baseline conditions, it is not critical to actively control these variables in some implementations of the technology. Such control could be achieved either in open-loop or closed-loop configurations.

The sensors and sensor arrays disclosed herein could be used with or without preconcentration of the analyte depending on the power levels and other system constraints demanded by the user. Regardless of the sampling mode, the characteristic patterns (both from amplitude and temporal features, depending on the most robust classification algorithm for the purpose) associated with certain disease states and other volatile analyte signatures can be identified using the sensors disclosed herein. These patterns are then stored in a library, and matched against the signatures emanating from the sample to determine the likelihood of a particular odor falling into the category of concern (disease or nondisease, toxic or nontoxic chemical, good or bad polymer samples, fresh or old fish, fresh or contaminated air, and the like).

Analyte sampling will occur differently in the various application scenarios. For some applications, direct headspace samples can be collected using either single breath and urine samples in the case of sampling a patient's breath or urine for the purpose of disease or health state differentiation and classification. In addition, extended breath samples, passed over a Tenax, Carbopack, Poropak, Carbosieve, or other sorbent preconcentrator material, can be obtained when needed to obtain robust intensity signals. The absorbent material of the fluid concentrator can be, but is not limited to, a nanoporous material, a microporous material, a chemically reactive material, a nonporous material and combinations thereof. In certain instances, the absorbent material can concentrate the analyte by a factor that exceeds a factor of about 10⁵, or by a factor of about 10² to about 10⁴. In another embodiment, removal of background water vapor is conducted in conjunction, such as concomitantly, with the concentration of the analyte. Once the analyte is concentrated, it can be desorbed using a variety of techniques, such as heating, purging, stripping, pressuring or a combination thereof.

Breath samples can be collected through a straw or suitable tube in a patient's mouth that is connected to a sample chamber (or preconcentrator chamber), with an analyte outlet available for capture to enable subsequent GC/MS or other selected laboratory analytical studies of the sample. In other applications, headspace samples of odorous specimens can be analyzed and/or carrier gases can be used to transmit the analyte of concern to the sensors to produce the desired response. In still other cases, the analyte will be in a liquid phase and the liquid phase will be directly exposed to the sensors; in other cases the analyte will undergo some separation initially and in yet other cases only the headspace of the analyte will be exposed to the sensors.

Using the device, sensors, and sensor arrays described herein, the analyte can be concentrated from an initial sample volume of about 10 liters and then desorbed into a concentrated volume of about 10 milliliters or less, before being presented to the sensor array.

Suitable commercially available adsorbent materials include, but are not limited to, Tenax TA, Tenax GR, Carbotrap, Carbopack B and C, Carbotrap C, Carboxen, Carbosieve SIII, Porapak, Spherocarb, and combinations thereof. Those skilled in the art will know of other suitable absorbent materials.

In another embodiment, removal of background water vapor is conducted in conjunction, such as concomitantly, with the concentration of the analyte. Once the analyte is concentrated, it can be desorbed using a variety of techniques, such as heating, purging, stripping, pressuring or a combination thereof. In these embodiments, the sample concentrator is wrapped with a wire through which current can be applied to heat and thus, desorb the concentrated analyte. The analyte is thereafter transferred to a sensor or sensor array.

In some cases, the array will not yield a distinct signature of each individual analyte in a region, unless one specific type of analyte dominates the chemical composition of a sample. Instead, a pattern that is a composite, with certain characteristic temporal features of the sensor responses that aid in formulating a unique relationship between the detected analyte contents and the resulting array response, will be obtained.

In one embodiment of signal processing, the Fisher linear discriminant searches for the projection vector, w, in the detector space, which maximizes the pairwise resolution factor, i.e., rf, for each set of analytes, and reports the value of rf along this optimal linear discriminant vector. The rf value is an inherent property of the data set and does not depend on whether principal component space or original detector space is used to analyze the response data. This resolution factor is basically a multi-dimensional analogue to the separation factors used to quantify the resolving power of a column in gas chromatography, and thus the rf value serves as a quantitative indication of how distinct two patterns are from each other, considering both the signals and the distribution of responses upon exposure to the analytes that comprise the solvent pair of concern. For example, assuming a Gaussian distribution relative to the mean value of the data points that are obtained from the responses of the array to any given analyte, the probabilities of correctly identifying an analyte as a or b from a single presentation when a and b are separated with resolution factors of 1.0, 2.0 or 3.0 are approximately 76%, 92% and 98%, respectively.

To compute the rf, from standard vector analysis, the mean response vector, xₐ, of an n-sensor array to analyte a is given as the n-dimensional vector containing the mean autoscaled response of each sensors, Aₐⱼ, to the a^{th} analyte as components such that
xₐ=(Aₐ₁, Aₐ₂, . . . Aₐₙ)

The average separation, |d|, between the two analytes, a and b, in the Euclidean sensor response space is then equal to the magnitude of the difference between xₐ and x_{b}. The noise of the sensor responses is also important in quantifying the resolving power of the sensor array. Thus the standard deviations, s_{a,d} and s_{b,d}, obtained from all the individual array responses to each of a and b along the vector d, are used to describe the average separation and ultimately to define the pairwise resolution factor as
rf=d_{w}/√(σ²_{a, w}+σ²_{b,w}).

Even if the dimensionality of odor space is fairly small, say on the order of 10¹, there is still interest in being able to model the biological olfactory system in its construction of arrays consisting of large numbers of receptor sites. In practice, correlations between the elements of a sensor array will necessitate a much larger number of sensors to successfully distinguish molecules. Furthermore, performance issues such as response time, signal averaging, or calibration ranges may use multiple sensors based on each material. Analysis of regions will add additional degrees of freedom if the components of the region are to be individually identified and will typically use large numbers of sensors. Fabrication of large numbers of sensors also enables the use of very powerful coherent signal detection algorithms to pull a known, but small amplitude, signal, out of a noisy background. Because of all of these issues, the number of sensors required to successfully span odor space in a practical device may rapidly multiply from the minimum value defined by the dimensionality of smell space.

The following examples are offered by way of illustration and not by way of limitation.

### EXAMPLES

A goal of this work was to explore whether it is possible to achieve enhanced sensitivity to a specific class of analyte vapors through choice of the polymeric component of the carbon black-polymer composite. The relative differential resistance change of carbon black composites, for example those formed from poly(55% ethyleneco-45% vinylacetate) (PEVA) and poly(ethylene oxide) (PEO), has been shown to be determined by the relative thickness change induced by sorption of analyte into the polymer film. Under such conditions, for a fixed detector volume and a fixed volume of sampled analyte, only the partial molar volume of the analyte and the analyte polymer/gas partition coefficient determine the dc resistance sensitivity of the chemiresistor composite detector. Sensitivity increases for a given analyte can therefore in principle be achieved by utilization of polymers that have higher polymer/gas partition coefficients for the analytes of interest. At some limit, however, the analyte detection sensitivity will be limited physically by the amount of analyte present in the sample stream, because at the highest polymer/gas partition coefficients, essentially all of the physically available analyte in a limited, finite sampled volume will be sorbed into the available detector film volume. An additional enhancement in sensitivity for composite chemiresistor detectors, whose signal transduction mechanism involves volume expansion as opposed to mass uptake, could in principle be achieved if specific chemical interactions could be induced to effect enhanced swelling of the polymer composite upon sorption of a given quantity of selected analytes. A still further enhancement in sensitivity can be achieved by having the vapor-induced swelling drive the conducting polymer composite across its percolation threshold, producing a very large change in film conductivity as a result of a relatively small change in film volume.

To explore these approaches, the performance towards volatile fatty acids of carbon black composites formed from the basic, amine-containing polymer, linear poly(ethylenimine) (l-PEI) was examined. Diversity in the vapor detector array has been achieved by incorporating different plasticizers into the carbon black-l-PEI composites, thereby maintaining high sensitivity to volatile organic acid vapors while facilitating differentiation between volatile fatty acids. A combination of relative differential resistance measurements, mass-related QCM-based frequency shifts, and ellipsometric thickness measurements has been used to evaluate the relative contributions of enhanced polymer/gas partition coefficients, chemically specific film swelling effects, and percolation threshold effects in determining the sensitivity of these l-PEI-carbon black composites to volatile fatty acids. In addition, the volatile fatty acid vapor detection properties have been compared to the detection of non-acidic analytes using l-PEI-carbon black composites and to the volatile fatty acid vapor detection performance of carbon black composite detectors that possess no specific chemical interactions towards this class of analyte vapors.

Substrates, detectors, vapor generation methods, and data analysis techniques are as described in co-pending application Ser. No. 09/409,644, as well as U.S. Pat. Nos. 6,631,333; 6,610,367, 5,788,833, and 5,571,401 (the disclosure of which are incorporated herein by reference). The carbon black used in all of the composites investigated in this work was Black Pearls 2000 (BP2000), a furnace black material that was generously donated by Cabot Co. (Billerica, Mass.). The polymers used in a standard array of carbon black-polymer composite detectors were: (polymer, manufacturer): 1, poly(ethylene oxide), Polysciences; 2, poly(55% o ethylene-co-45% vinyl acetate), Polysciences; 3, poly(72% butadiene-co-28% styrene), Scientific Polymer Products; 4, poly(vinyl carbazole), Polysciences; 5, poly(vinyl acetate), Scientific Polymer Products; 6, polycaprolactone, Polysciences; 7, polysulfone, Polysciences; 8 poly(N-vinyl pyrrolidone), Scientific Polymer Products; 9, poly(4-vinyl phenol), Polysciences; 10, poly(methyloctadecyl siloxane), Polysciences; 11, linear poly(ethyelene imine), Polysciences. Poly(4-vinylpyridine), obtained from Aldrich, was also used in this study.

A single solution containing the carbon black suspension and the polymer of interest was used to prepare all the detectors of a given composition that were investigated in this work. Unless otherwise indicated, the solutions consisted of 80 wt % (160 mg) polymer and 20% wt % (40 mg) carbon black in 20 ml of solvent, with the solvent typically tetrahydrofuran (THF) or methanol. All polymers and solvents were used as received. Au electrical contact leads were deposited onto the substrate, and films of the polymer-carbon black composites were then sprayed on to the region between the leads to give an initial resistance of ˜100 κΩ.

The carrier gas for all experiments was oil-free air, obtained from the general compressed air laboratory source containing 1.10±0.15 ppth (parts per thousand) of water vapor. The air was filtered to remove particulates, but deliberately was not dehumidified or otherwise purified. When water was used as the background analyte, the carrier gas was ultra-zero air. Fluctuations in laboratory temperature, 21.5±1.5° C., could cause an ≈10% error in setting and controlling the vapor concentrations between nominally identical exposures over the course of the data collection analyzed in this work. No temperature control of the apparatus or of the carbon black-polymer composite detectors was implemented. Flow rates for typical analyte exposures were maintained at 5 L min⁻¹. Partial pressures of non-acidic analytes were P/P°=0.050 while further dilution (as indicated below) were used in the case of acidic analytes to a l-PEI array.

A 16-detector array based on l-PEI composites consisted of 2 l-PEI detectors, l-PEI plasticized with di-(2-ethylhexyl)-phthalate and with diethylene glycol dibenzoate each at 0.15, 0.30, 0.45 and 0.60 mass ratios of plasticizer to polymer, l-PEI plasticized with N-ethyl toluenesulfonamide at 0.15, 0.30, and 0.45 mass ratios, and poly(4vinylpyridine)/l-PEI (50 wt. % of each) plasticized with di-(2-ethylhexyl)-phthalate at 0.30, 0.45 and 0.60 mass ratios of plasticizer to polymer. The flow rate of the vapor stream entering the exposure chamber (˜1 liter in total volume) was maintained at 5 L min⁻¹. The fractional acidic analyte vapor pressures at 21° C. exposed to the l-PEI detector array are: acetic acid (3.2 ppm), proprionic acid (1.3 ppm), butyric acid (350 ppb), valeric acid (1.0 ppm), and hexanoic acid (1.0 ppm).

Exposures of hexanoic acid were done as usual with mass flow controllers and bubblers. Exposures of the remaining acidic analytes were performed by filling 10 L teflon bags with a precisely known concentration of the acid vapor and removing a stream of this diluted vapor with a sampling pump and further diluting it with a background stream of laboratory air followed by delivery to the l-PEI array. To initiate an experiment, the detectors were placed into the flow chamber and a background flow of laboratory air was introduced until the resistance of the detectors stabilized. Each exposure consisted of a three-step process that began with 60 s of airflow to achieve a baseline resistance. The detectors were then exposed to analyte vapor at a controlled concentration as stated above, followed by a flow of clean air for a time equal to the total exposure time, restoring the baseline resistance values. Except where otherwise noted, the exposure time was sufficiently long that the maximum response value, ΔRₘₐₓ/R_{b}, where ΔRₘₐₓ is the maximum resistance change of the detector during an analyte exposure and R_{b} is the baseline resistance of the detector, was a very good approximation to the change in the steady-state resistance value of the detectors in response to the specified analyte. Each acid vapor was exposed to the detectors 5 times, in random sequence, with each exposure lasting 300 s. Within each experiment, every exposure was assigned a randomly generated index number using the Microsoft Excel random number generator, and the analytes were presented to the detectors in increasing index number order.

Principal component analysis (PCA) of the detector array response data was performed using macros written in Microsoft Excel, and the data were plotted using Delta Graph and Claris Works. Data were normalized over the entire array for a given exposure rather than over a collection of exposures for a given detector. Normalization was performed by taking the sum of the detector responses for a given exposure and dividing the response of each detector by this summed value. This normalization procedure corrects for differences in analyte concentration that are a consequence of the differing vapor pressures of the test analytes. The data were not auto-scaled prior to use in principal component analysis.

Quartz crystal microbalance (QCM) measurements were performed on carbon black-polymer films in conjunction with simultaneous resistance measurements of these composite vapor detectors. QCM crystals (10 MHz resonant frequency, blank diameter of 13.7 mm) with an active electrode diameter of 5.1 mm were obtained from International Crystal Manufacturing. To verify the relationship between the observed QCM frequency shift and the mass loading of the crystal, the QCM crystals were weighed before and after film deposition, using a Cahn model C-35 microbalance with a sensitivity of 0.0010 mg. The QCM crystal was held in a chamber and appropriate contacts were provided for resistance and frequency measurements. Frequency measurements were obtained using a model 5283A Hewlett Packard frequency counter and resistance measurements were made using a Keithley model 2002 digital multimeter. Flow meters were used to control the airflow and to introduce the desired concentration of analyte vapor into the chamber.

QCM measurements were also performed in conjunction with ellipsometric measurements of film thickness. The chamber holding the QCM crystal for these measurements had physical slots so that the laser used for ellipsometry could reflect off the surface of the QCM crystal. Ellipsometry was performed on a model L116C Gaertner Scientific ellipsometer. Optical constants for the gold electrode and for the index of refraction of the unfilled polymer were obtained from the literature, while the optical absorption coefficient for the polymer film was determined experimentally. For l-PEI exposed to acetic acid, increased mass uptake and swelling levels necessitated that the optical constants be determined before each thickness measurement at a given value of P/P°, where P is the partial pressure of the analyte and P° is the vapor pressure of the analyte at room temperature. For methanol as the analyte vapor, the optical constants did not change appreciably during the course of the exposure, and thus were fixed at the values determined for the unswollen film. A typical unswollen film thickness was approximately 100 nm.

Data for the relative mass uptake, resistance responses, and swelling for a given l-PEI film were obtained by exposing the polymer-coated QCM crystal to increasing partial pressures of the analyte vapor of interest. To initiate an experiment, background laboratory air was passed over the l-PEI-coated QCM crystals for ≈30 min. Analyte vapor was then passed over the QCM crystal at increasing P/P° values, and data were recorded after 5 min at each P/P° value. Resistance, frequency, and thickness values were recorded manually. When exposed to methanol vapor, minimal (<10%) variance was observed between the relative mass, resistance, or thickness responses of different l-PEI films at a given P/P°. For acetic acid, successive relative mass uptake, resistance response, or thickness measurements were relatively reproducible for a l-PEI given film, and the measured values differed by 10-20% of the mean value of each measurement. The measured relative mass uptake at a given partial pressure of acetic acid often differed significantly, however, for different films. Nevertheless, the relationship between relative mass uptakes and relative thickness increases or between relative mass uptakes and relative resistance responses were consistent between different l-PEI films to within 10-20%. Thus, mass uptake (and not P/P°) values were used to derive the relationships between thickness increases and the corresponding resistance responses. The data displayed in the figures are for a single representative experiment of the behavior of l-PEI exposed to each analyte vapor. Errors at each P/P° value are approximately 20% of the mean quoted values of the relative mass uptake, resistance, and thickness change, respectively.

Response of Various Polymer-Carbon Black Composites To Volatile Fatty Acids were analyzed. FIG. 2 depicts the relative differential resistance behavior of various insulating polymer-carbon black composite vapor detectors when exposed to acetic acid at P/P°=0.010, where P is the partial pressure of analyte and P° is the vapor pressure of the analyte at room temperature. The l-PEI-carbon black detector clearly exhibited a significantly enhanced ΔRₘₐₓ/R_{b} response as compared to the other carbon black insulating organic polymer detector films. The mean response of a set of five l-PEI carbon black composite detectors to five exposures of acetic acid at P/P°=0.010 was ΔRₘₐₓ/R_{b}=24.5, while the most sensitive non-amine carbon black-polymer composite detector, a poly(4-vinylpyridine)-carbon black composite chemiresistor, exhibited a mean ΔRₘₐₓ/R_{b} value of 0.23, i.e., approximately a value of 100-fold smaller than that of the l-PEI composite detectors for the same analyte exposures. The increased sensitivity of the l-PEI sensors for fatty acids was highly unexpected and would not have been expected by one of skill in the art. Other non-amine carbon black polymer composites gave ΔRₘₐₓ/R_{b} values typically an additional order of magnitude lower (≈0.02).

At these high ΔRₘₐₓ/R_{b} levels, the responses were somewhat variable between detectors, but the responses of an individual detector were quite reproducible. The average ΔRₘₐₓ/R_{b} responses for five l-PEI-carbon black detectors to five nominally identical exposures of acetic acid at P/P°=0.010 were 10.2±2.1, 33.4±4.2, 29.9±1.6, 25.7±4.4, and 23.2±5.8, respectively. The variation in ΔRₘₐₓ/R_{b} for a given detector showed systematic trends across detectors for the various exposures, most likely indicating small temperature fluctuations and/or a slight variation in the output of the mass flow controllers that produced the analyte gas mixture. The detection limit for acetic acid on l-PEI-carbon black composites was ≈85 ppb (as extrapolated from the response of the detector at P/P°=0.0050), as compared to 1 ppm and 25 ppm for carbon black composites of poly(sulfone) or poly(ethylene oxide), respectively.

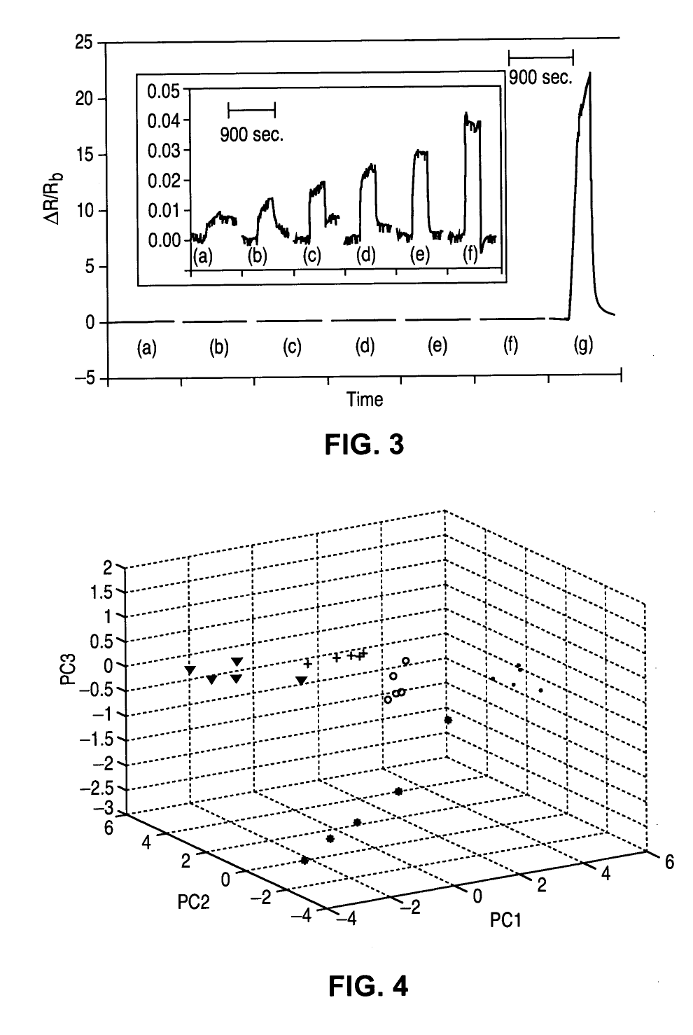

Response of l-Poly(ethylenimine) Composites to Acidic and Non-Acidic Organic Vapors. FIG. 3 presents the ΔR/R_{b} responses of a l-PEI-carbon black composite detector to various volatile organic vapors and to water vapor. The l-PEI detectors were exposed to each analyte at P/P°=0.050, with the exception of acetic acid, which was presented at P/P°=0.010. The responses of l-PEI-carbon black detectors to acetic acid were generally about three orders of magnitude larger than their responses to the other analytes, thus the sensitivities normalized with respect to partial pressure of the analyte, (ΔRₘₐₓ/R_{b})/(P/P°), were ≈10⁴ higher for the l-PEI-carbon black detectors exposed to acetic acid than when exposed to non-acidic organic vapor analytes. Because the vapor pressure of water is so much higher than that of acetic acid, the l-PEI-carbon black detectors are more sensitive, on a vapor phase concentration basis, to acetic acid by a factor of ≈10⁵ (i.e., by their signal/noise ratios at 160 ppm of acetic acid and at 1.25 ppth of water vapor).

Exposure of l-PEI-carbon black composite detectors to longer chain fatty acid vapors such as hexanoic acid also produced relatively large (ΔRₘₐₓ/R_{b}) responses, although when exposed to less volatile acids the detectors did not reach steady-state within the 5 min exposure period of the present study. For example, the resistance response (ΔRₘₐₓ) of a l-PEI-20% carbon black detector exceeded 6×10⁸ ohms but did not reach equilibrium after ≈120 min of exposure to hexanoic acid at P/P°=0.010 (520 ppb). This is expected given the low vapor pressure of hexanoic acid and the limited supply of analyte available for sorption into the polymer film at the flow rates used in this study.

Classification of Volatile Fatty Acids Using Arrays of Plasticized Poly(ethylenimine)-Carbon Black Vapor Detectors. Differentiation among volatile fatty acids was accomplished through fabrication of an array of l-PEI-carbon black and poly (4-vinylpyrrolidone)-carbon black composite detectors. Plasticizers were used to create chemical diversity among the detectors while maintaining the high sensitivity of the amine-containing detectors to volatile fatty acid vapors.

Table 5 presents the absolute ΔRₘₐₓ/R_{b} response data for this array when exposed to five different volatile fatty acids each at the following P/P° values: acetic acid (2.00×10⁻⁴); propionic acid (4.00×10⁻⁴); butyric acid (4.00×10⁻⁴); valeric acid (4.70×10⁻³); and hexanoic acid (3.65×10⁻²). FIG. 4 presents the normalized ΔRₘₐₓ/R_{b} response data for this array in principal component space. Each analyte produced a distinct response cluster that was differentiable from the response cluster of every other analyte investigated. A quantitative measure of the separation between the vapor response patterns is presented in Table 6, which depicts the pairwise resolution factors (RF) for the various vapors. These RF values reflect the ability of the detector array to differentiate between a given vapor pair, with an RF value of 3 implying ≈97% success rate in differentiation between two analytes through use of a suitable classification algorithm.

TABLE 5
Absolute ΔRmax/Rb responses of an array of polymer/20% carbon black exposed
to various volatile fatty acids

| | Acetic acid | Propionic acid | Butyric acid | Valcric acid | Hexanoic Acid |
|---|---|---|---|---|---|
| | (3.2 ppm) | (1.3 ppm) | (350 ppb) | (1.0 ppm) | (1.0 ppm) |
| l-PEI | 0.140 ± 0.022 | 0.0676 ± 0.0104 | 0.0442 ± 0.0045 | 0.0896 ± 0.0316 | 0.172 ± 0.052 |
| l-PEI/0.15 DOP | 0.147 ± 0.031 | 0.0711 ± 0.0100 | 0.0249 ± 0.0039 | 0.0637 ± 0.0103 | 0.297 ± 0.066 |
| l-PEI/0.30 DOP | 0.134 ± 0.025 | 0.0514 ± 0.0038 | 0.0303 ± 0.0010 | 0.0340 ± 0.0107 | 0.0545 ± 0.0069 |
| l-PEI/0.45 DOP | 0.0461 ± 0.0074 | 0.0205 ± 0.0009 | 0.0134 ± 0.0012 | 0.0207 ± 0.0058 | 0.0381 ± 0.0038 |
| l-PEI/0.60 DOP | 0.0173 ± 0.0037 | 0.0110 ± 0.0009 | 0.00857 ± 0.00119 | 0.0143 ± 0.0039 | 0.0248 ± 0.0016 |
| l-PEI/0.15 DGB | 0.0789 ± 0.0120 | 0.0445 ± 0.0074 | 0.0118 ± 0.0023 | 0.0190 ± 0.0019 | 0.0547 ± 0.0065 |
| l-PEI/0.30 DGB | 0.0256 ± 0.0021 | 0.0132 ± 0.0018 | 0.00855 ± 0.00101 | 0.0135 ± 0.0020 | 0.0256 ± 0.0030 |
| l-PEI/0.45 DGB | 0.0140 ± 0.0013 | 0.00845 ± 0.00171 | 0.00859 ± 0.00113 | 0.0145 ± 0.0030 | 0.0294 ± 0.0024 |
| l-PEI/0.60 DGB | 0.0127 ± 0.0015 | 0.00694 ± 0.00128 | 0.00571 ± 0.00090 | 0.00966 ± 0.00123 | 0.0203 ± 0.0017 |
| l-PEI/0.15 ETS | 0.0365 ± 0.0059 | 0.0356 ± 0.0082 | 0.00546 ± 0.00124 | 0.0175 ± 0.0023 | 0.0335 ± 0.0032 |
| l-PEI/0.30 ETS | 0.0256 ± 0.0015 | 0.0125 ± 0.0023 | 0.00841 ± 0.00111 | 0.00981 ± 0.00185 | 0.0168 ± 0.0010 |
| l-PEI/0.45 ETS | 0.000623 ± 0.000341 | 0.00277 ± 0.00039 | 0.00427 ± 0.00047 | 0.00607 ± 0.00133 | 0.00965 ± 0.00085 |
| VPEI/0.30 DOP | 0.0107 ± 0.0008 | 0.00705 ± 0.0012 | 0.00392 ± 0.00093 | 0.00423 ± 0.00129 | 0.00530 ± 0.00057 |
| VPEI/0.45 DOP | 0.00781 ± 0.00040 | 0.00611 ± 0.00071 | 0.00415 ± 0.00071 | 0.00483 ± 0.00155 | 0.00530 ± 0.00057 |
| VPEI/0.60 DOP | 0.00713 ± 0.00025 | 0.00609 ± 0.00048 | 0.00468 ± 0.00083 | 0.00586 ± 0.00227 | 0.00519 ± 0.00056 |

DOP = di-(2-ethylhexyl)-phthalate;
DGB = diethylene glycol dibenzoate;
ETS = N-ethyl-lolucnesulfonamide;
VEPI = poly(4-vinylpyridine)/ linear poly(ethylenimine) 50 wt % of each.

TABLE 6
Pair wise resolution factors obtained using the Fisher linear discriminant

| | Propionic | | | |
|---|---|---|---|---|
| | acid | Butyric acid | Valeric acid | Hexanoic Acid |
| Acetic acid | 22 | 69 | 59 | 80 |
| Propionic acid | | 19 | 52 | 14 |
| Butyric acid | | | 39 | 20 |
| Valeric acid | | | | 16 |

Correlation Between QCM Frequency Shifts, Resistance Changes, and Thickness Changes of Poly(ethylenimine) Films. The response of a sorption-based chemiresistive vapor detector can be described numerically in terms of three distinct physical processes. The first process describes the amount of analyte sorbed by the polymer, and is expressed as the differential polymer/gas partition coefficient, dK, where dK≡∂[A]ₚ/∂[A]ᵥ, with [A]ₚ representing the concentration of analyte in the polymer phase and [A]ᵥ representing the concentration of analyte in the vapor phase. The second factor, S_{h,A}, describes the differential swelling of the polymer that is produced by the uptake of analyte, with S_{h,A}≡∂(Δh/h)/∂([A]ₚ), where h is the thickness of a semi-infinite polymer film prior to exposure to the analyte and Δh equals the change in film thickness in response to differential analyte sorption. The third factor, S_{R,h}≡∂(ΔRₘₐₓ/R_{b})/∂(Δh/h), expresses the relative differential resistance change of the chemiresistor in response to differential swelling due to analyte sorption. Hence the differential ΔRₘₐₓ/R_{b} response, d(ΔRₘₐₓ/R_{b}), produced by a differential change in analyte concentration in the vapor phase, d[A]ᵥ is:
d(ΔRₘₐₓ/R_{b})={∂(ΔRₘₐₓ/R_{b})/∂(Δh/h)}{∂(Δh/h)/∂([A]ₚ)}{∂[A]ₚ/∂[A]ᵥ}d[A]ᵥ (1)
i.e., d(ΔRₘₐₓR/_{b})=S_{R,h}S_{h,A}dK d[A]ᵥ (2)
The overall sensitivity, S_{R,A}, of the relative differential resistance response to a change in the partial pressure of analyte vapor, dP_{A}, can thus be expressed as:
d(ΔRₘₐₓ/R_{b})=S_{R,h},S_{h,A}dK d[A]ᵥ=S_{R,A} dP_{A} if S_{R.A}={S_{R.h} S_{h,A}·dK/(R T)} (3)
with R the ideal gas constant and T the temperature in degrees Kelvin. Measurements of the resistance change, thickness change, and mass uptake of l-PEI-based films were performed to elucidate the relative contributions of changes in S_{R,h},S_{h,A} and dK on the ΔRₘₐₓ/R_{b} vs P behavior of l-PEI-carbon black chemiresistive vapor detectors.

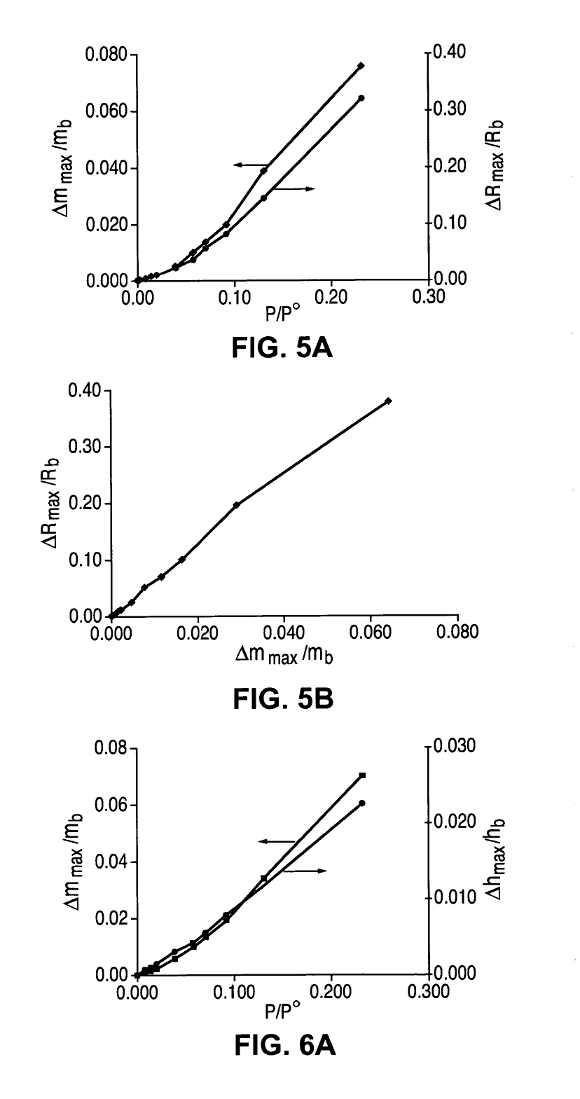

Behavior of l-Poly(ethylenimine) Films During Sorption of Methanol. FIG. 5a shows the relative differential resistance change, ΔRₘₐₓ/R_{b}, and the relative differential mass uptake, Δmₘₐₓ/m_{b}, where m is the mass per unit area of the polymer film coating and Δmₘₐₓ is the maximum change in mass per unit area of the film upon exposure to the analyte of interest, of a QCM crystal coated with a carbon black-l-PEI composite film, as a function of the partial pressure of methanol in a background of laboratory air. The observed frequency changes of the QCM crystal were converted into mass uptakes through use of the Sauerbrey equation. FIG. 5b shows the dependence of ΔRₘₐₓ/R_{b} on the amount of methanol sorbed into the l-PEI composite as derived from the data of FIG. 5a, with the quantity of sorbed methanol expressed in terms of the relative mass uptake of analyte into the polymer.

The frequency shift of the polymer-coated QCM crystals produced by sorption of the analyte vapor into the polymer film was <2% of the resonant frequency of the polymer-coated crystal (typically 9.97 MHz). Under such conditions, prior work has concluded that mechanical losses are minimal and that the frequency shifts are predominantly due to changes in mass uptake, justifying the use of the Sauerbrey equation to deduce the mass uptake values from the observed QCM frequency shifts. Independent confirmation of this assumption was obtained in this work through comparison of the frequency shifts measured on a polymer-coated QCM with direct measurements of the sorbed mass uptake of that polymer film using a Cahn microbalance. To perform this comparison, a polymer-coated QCM crystal was weighed before and after deposition of the film, with the mass change of this film-coated crystal determined during and after sorption of test analyte vapors. The mass uptake values upon exposure of a PEO film for 5 min to CHCl₃ at P/P°=0.40 obtained by QCM deviated by less than 10% from the mass uptake values determined using the tared microbalance. The 1300 Hz frequency shift of this coated QCM crystal upon exposure to CHCl₃ corresponded to >20% relative differential mass uptake (Δmₘₐₓ/m_{b}>0.2) of analyte vapor, indicating that the frequency shifts as measured by QCM are accurately converted into mass uptake values for at least this level of analyte sorption into the polymer film.

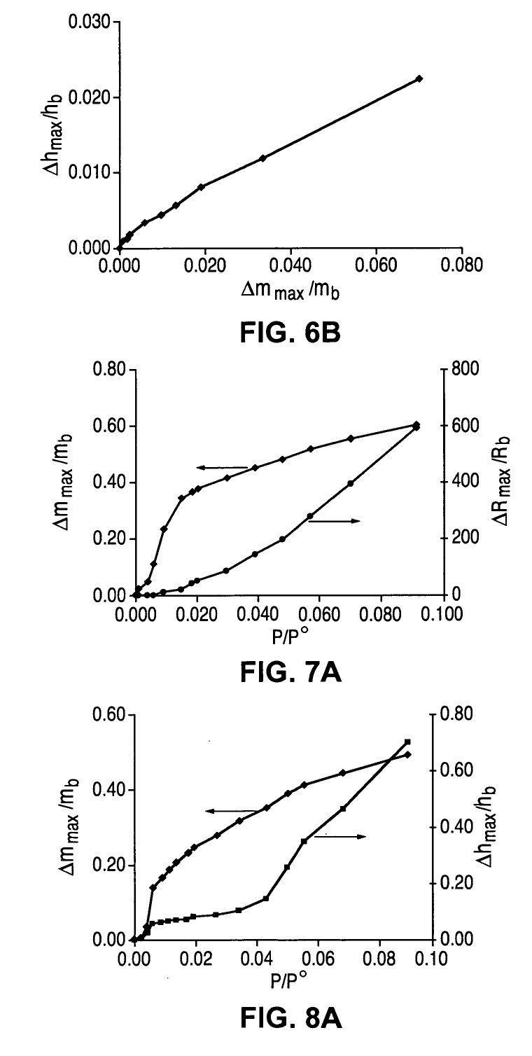

Mass uptake measurements are not sufficient to describe the fundamental ΔRₘₐₓ/R_{b} response behavior of carbon black-polymer composites to different vapors, because sorption-induced polymer swelling, as opposed to sorption-related mass uptake, has been shown to be the key quantity that determines the magnitude of ΔRₘₐₓ/R_{b} for a variety of analytes. Thickness measurements were therefore also performed on l-PEI films as a function of analyte partial pressure. Measurements of film thickness, h, directly using fixed-wavelength ellipsometry required the use of films that did not contain the optically scattering carbon black component, so ellipsometry measurements on the pure l-PEI films were correlated with resistance measurements on carbon black-l-PEI composites through collection of mass uptake data on both types of films. FIG. 6a displays the mass uptake of a QCM crystal coated with pure l-PEI and also displays the relative thickness change, Δₕₘₐₓ/h_{b}, where Δhₘₐₓ is the maximum thickness change observed during analyte exposure, as a function of the partial pressure of methanol vapor.

The relative differential mass uptakes were the same, within experimental error, at a given partial pressure of methanol for the pure and carbon black composite l-PEI films (c.f. FIG. 5a and FIG. 6a), indicating that at these loading levels the carbon black filler is predominantly a spectator in determining the analyte sorption properties of the carbon black-polymer composite. Analogous behavior has been observed previously for PEVA and PEO films in the presence of a variety of analyte vapors.

A plot of Δhₘₐₓ/h_{b} vs ΔMₘₐₓ/M_{b} from the data of FIG. 6a indicates that the observed relative differential thickness change is linearly proportional to the relative differential mass change (FIG. 6b). This behavior is also in accord with observations that have been made previously on sorption-induced swelling of PEVA and PEO films. At the small relative mass loadings and small relative thickness changes produced by sorption of methanol for P/P°<0.25 into l-PEI, the value of ΔMₘₐₓ/M_{b} is related by a proportionality constant to [A]ₚ. Hence the ΔMₘₐₓ/M_{b} vs P/P° data of FIGS. 5a and 6a indicate that dK is approximately constant over the investigated range of methanol partial pressures. From eq (2), the ΔRₘₐₓ/R_{b} VS P/P° data of FIG. 5a therefore indicate that the S_{R,h} S_{h,A} product is constant for this system over the range methanol partial pressures investigated. Additionally, because [A]ₚ is proportional to ΔMₘₐₓ/M_{b}, the data of FIG. 5b indicate that Sh.A is essentially constant. Hence, from eq (2) and either FIG. 5a or FIG. 5b, S_{R,h} is essentially constant. Thus, the signal of interest, ΔRₘₐₓ/R_{b}, is linearly proportional to the methanol partial pressure with a constant of proportionality equal to S_{R,h} S_{h,A} dK/(R T).

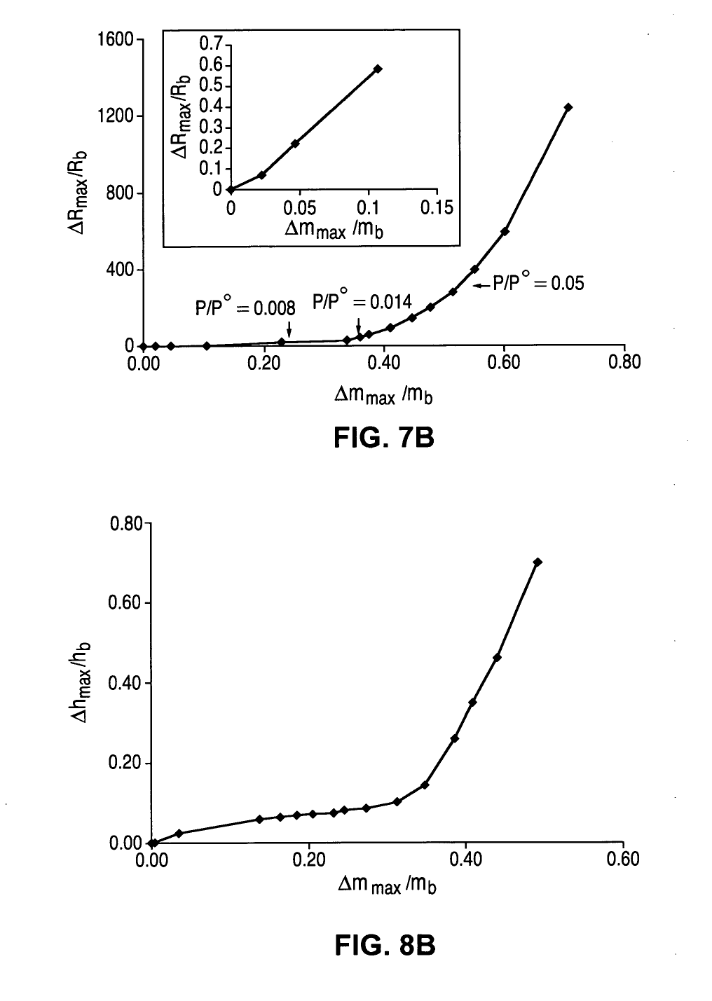

Behavior of 1-Poly(ethylenimine) Films During Sorption of Acetic Acid. Strikingly different behavior was observed, however, for the response of l-PEI films to acetic acid. FIG. 7a presents the relative differential mass uptake for l-PEI-carbon black composites coated onto QCM crystals as a function of the partial pressure of acetic acid in a laboratory air background, and FIG. 8a presents analogous data for pure l-PEI films. The value of ∂(Δmₘₐₓ/m_{b})/∂(P/P°) at low P/P° values indicates that the differential polymer/gas partition coefficient for acetic acid into l-PEI is significantly larger, as expected, than that of methanol (c.f. FIGS. 5a, 6a, 7a, and 8a). Above P/P°≈0.020, the relative differential mass uptake of acetic acid by l-PEI changes behavior, with Δmₘₐₓ/m_{b} increasing slowly as P/P° is increased.

FIG. 7a also shows the observed dependence of ΔRₘₐₓ/R_{b} of the l-PEI-carbon black composite on the partial pressure of acetic acid vapor. In contrast to the behavior of ∂(Δmₘₐₓ/m_{b})/∂(P/P°), the value of S_{R,A}=∂(ΔRₘₐₓ/R_{b})/∂(P/P°) increased as P/P° increased (FIG. 7a). As displayed in FIG. 8a, Δhₘₐₓ/h_{b} showed a yet different behavior, exhibiting an initial increase at low analyte concentrations, and then increasing at a relatively constant until ≈P/P°=0.04, at which point Δhₘₐₓ/h_{b} increased significantly in response to further increases in P/P° of acetic acid.

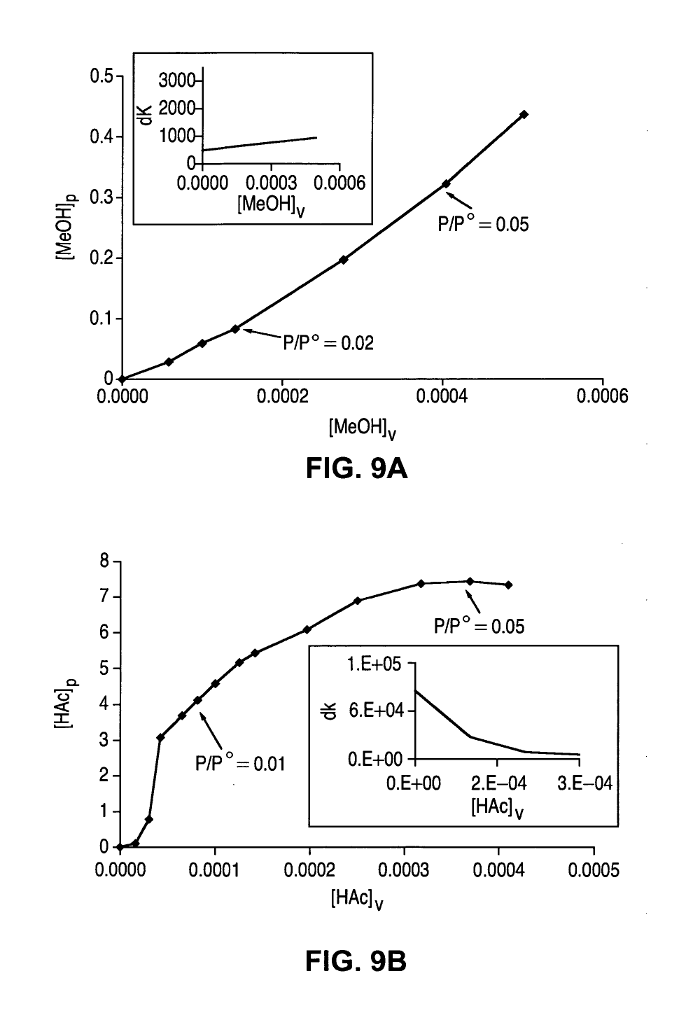

An analysis of the relationships between changes in the relative mass uptake, resistance, and thickness values, respectively, for the l-PEI films was undertaken to elucidate the underlying principles that govern sorption behavior of acetic acid into these polymer films. FIGS. 8a and 8b depict plots of the analyte concentration in the pure l-PEI film as a function of the concentration of methanol and acetic acid vapor, respectively. The sorbed mass was converted into an analyte concentration by dividing the moles of sorbed analyte per unit area by the ellipsometrically measured film thickness at each value of P/P°. For methanol, the differential partition coefficient dK into l-PEI is nearly constant as a function of analyte concentration, with dK˜5×10² for the range of P/P° values studied (P/P°<0.1). For acetic acid, however, at low acetic acid partial pressures (P/P°<0.010) the differential partition coefficient is up to three orders of magnitude higher than that for methanol, and dK is at least 1 order of magnitude higher for acetic acid than for methanol over the entire range of partial pressures investigated (FIG. 9a, inset). Hence the predominant factor producing the observed increase in S_{R,A} at low vapor phase analyte concentrations (P/P°<0.005) arises from the increased polymer/gas partition coefficient for acetic acid relative to methanol being sorbed into l-PEI.

However, differences in sorption between methanol and acetic acid obviously cannot account fully for the behavior of the ΔRₘₐₓ/R_{b} response of the l-PEI-carbon black composites as a function of the partial pressure of acetic acid. A plot of the dependence of ΔRₘₐₓ/R_{b} vs the amount of sorbed acetic acid (FIG. 7a) indicates that ΔRₘₐₓ/R_{b}, is linearly related to ΔMₘₐₓ/M_{b} for low values of ΔMₘₐₓ/M_{b} (FIG. 7b inset), but further increases in the sorption of analyte result in an increase in the value of ∂(ΔRₘₐₓ/R_{b})/∂(Δmₘₐₓ/m_{b}). This behavior clearly is a consequence of the data of FIG. 7a, in which increases in acetic acid partial pressure above P/P°=0.03 produce relatively little additional mass uptake but produce a monotonically increasing value of S_{R,A}. A plot of the relative differential thickness change, Δhₘₐₓ/h_{b}, of the pure l-PEI film as a function of the relative differential mass uptake, Δmₘₐₓ/m_{b}, (FIG. 8b) reveals that some of the sensitivity increase of ΔRₘₐₓ/R_{b} with respect to Δmₘₐₓ/m_{b} occurs because ∂(Δhₘₐₓ/h_{b})/∂(Δmₘₐₓ/m_{b}) increases with increasing Δmₘₐₓ/m_{b}. Hence, above a certain quantity of sorbed acetic acid, the amount of relative polymer swelling increases per unit of sorbed mass, indicating the presence of specific interactions between the analyte and the polymer that cause enhanced swelling, and therefore an enhanced ΔRₘₐₓ/R_{b} response, in this range of acetic acid sorption.

If the entire ΔRₘₐₓ/R_{b} vs P/P° sensitivity increase of FIG. 7a resulted from an analyte-induced enhancement in polymer swelling at high mass loadings of acetic acid into the polymer film (FIG. 8b), then plots of ΔRₘₐₓ/R_{b} vs Δhₘₐₓ/h_{b} should be straight lines (having a slope equal to S_{R,h}), regardless of the factors controlling the quantity of analyte absorbed or the degree of polymer swelling produced by such analyte sorption. Such behavior has been observed previously for PEO and PEVA sorption of a variety of organic analyte vapors.³⁷ The mass uptake of the pure and carbon black composite l-PEI films was used as the independent variable to link the ellipsometric thickness measurements with the do electrical resistance measurements. To establish this correlation, the measured ΔRₘₐₓ/R_{b} vs Δmₘₐₓ/m_{b} data for the composite films were used to predict what value of ΔRₘₐₓ/R_{b} would be expected for the Δmₘₐₓ/m_{b} values measured for the non-filled polymer films at the various analyte concentrations used in the ellipsometric measurements. The predicted value of ΔRₘₐₓ/R_{b} was then plotted vs. the Δhₘₐₓ/h_{b} values at the corresponding ΔMₘₐₓ/M_{b} value of the analyte.

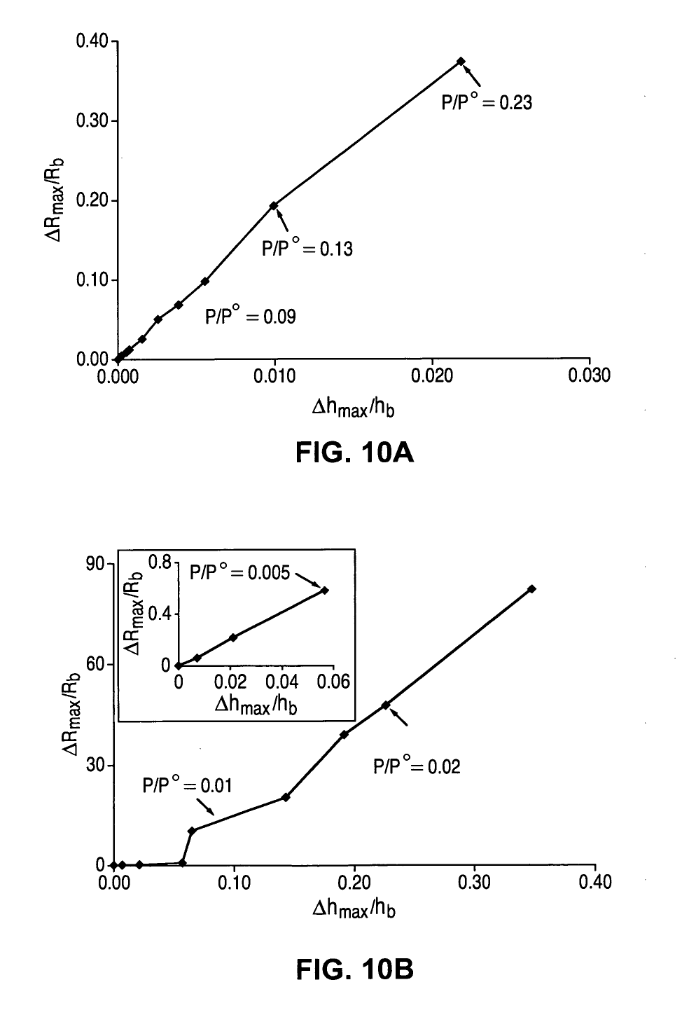

FIG. 10 depicts plots of ΔRₘₐₓ/R_{b} vs ΔHₘₐₓ/h_{b} for the sorption of methanol and acetic acid, respectively, into l-PEI films. For methanol, ΔRₘₐₓ/R_{b} is linearly related to Δhₘₐₓ/h_{b} with a value of S_{R,h}=(ΔRₘₐₓ/R_{b})/∂(Δhₘₐₓ/h_{b})≈15 (FIG. 10a). These observations are accord with previous studies which indicate that the degree of swelling produced by analyte sorption is directly related to the magnitude of ΔRₘₐₓ/R_{b}, regardless of the analyte or analyte concentration that was used to produce that particular amount of film swelling.³⁷ As displayed in FIG. 10b (inset), at low P/P° values, sorption of acetic acid into l-PEI follows this same behavior, with nearly the same value of ∂(ΔRₘₐₓ/R_{b})/∂(Δhₘₐₓ/h_{b}) (≈12). Thus, in this regime, the increase in overall system sensitivity, S_{R,A}, for acetic acid relative to methanol originates exclusively from the difference in polymer/gas partition coefficients, dK, and secondary charge repulsion interactions due to proton transfer between acetic acid and l-PEI for sorption of the two different analytes into the l-PEI film (FIGS. 5a, 6a, 7a, 8a, 9a).

The dependence of ΔRₘₐₓ/R_{b} on Δhₘₐₓ/h_{b} changes significantly, however, at the very high relative differential swellings that are obtainable for P/P°>0.01 of acetic acid (FIG. 10b). The large increase in the value of S_{R,h},=∂(ΔRₘₐₓ/R_{b})/∂(Δhₘₐₓ/h_{b}) indicates that in this regime another signal transduction/amplification process contributes significantly to the observed system sensitivity towards acetic acid vapor. Prior work has shown that the ΔRₘₐₓ/R_{b} sensitivity of carbon black-polymer composites to polymer swelling undergoes a significant change when the percolation threshold is reached. At the percolation threshold, a relatively small additional amount of swelling of the insulating polymer component of the composite dramatically affects the conductivity through the percolation network of conductive particles that dominate the do electrical conductance of the film. Hence the value of S_{R,h} in this regime will be increased significantly relative to the value of S_{R,h} observed when the composite is far below the percolation threshold.

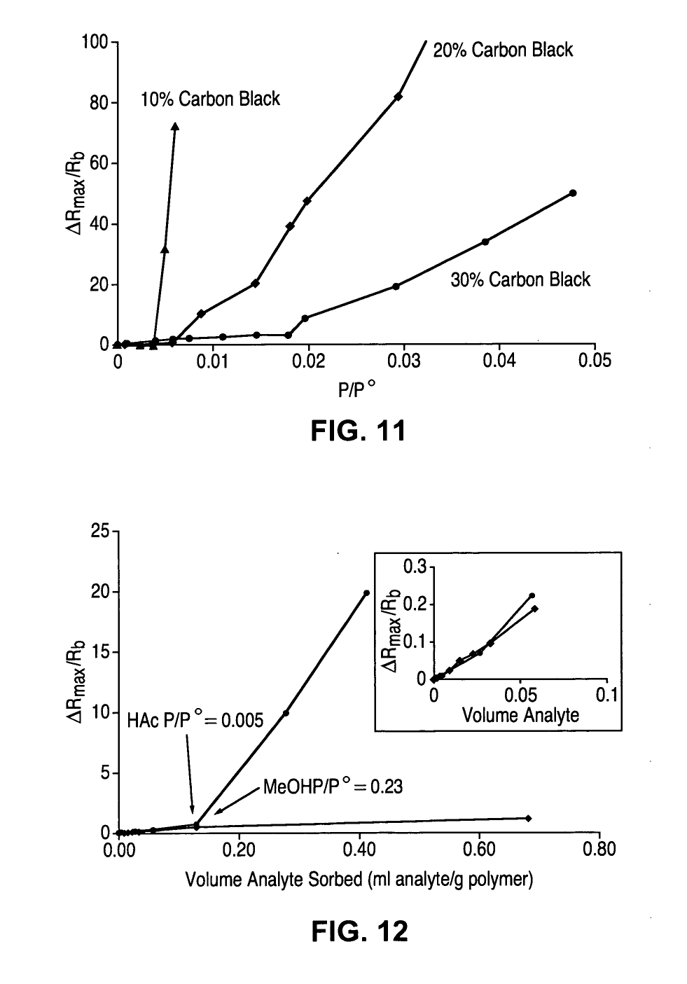

To explore whether the percolation threshold behavior was responsible for the observed change in ∂(ΔRₘₐₓ/R_{b})/∂(Δhₘₐₓ/h_{b}) upon sorption of relatively high amounts of acetic acid, ΔRₘₐₓ/R_{b} was evaluated as a function of P/P° for different amounts of carbon black used to form the l-PEI-carbon black composite chemiresistors. As displayed in FIG. 11, at very low P/P° values of acetic acid, the three different carbon black-l-PEI composites displayed very similar values of ∂(ΔRₘₐₓ/R_{b})/∂(ΔP/P°). However, at higher P/P° values, abrupt large changes were observed in ∂(ΔRₘₐₓ/R_{b})/∂(ΔP/P°). Furthermore, these changes were observed at different P/P° values for the different l-PEI-carbon black composites. The component of S_{R,A} that is not accounted for by changes in S_{h,A} or dK (FIG. 8b, 10b) is therefore ascribable to the transition of these composites through the percolation threshold. This transition produces a much larger value of S_{R,h} than is obtained from sorption of methanol or from sorption of low concentrations of acetic acid into l-PEI. Because the percolation threshold is a function of the carbon black loading of the composite,^{45,46} the effect should be less pronounced for the l-PEI-30% carbon black composites than for the l-PEI composite detectors with lower carbon black loadings, in accord with the data of FIG. 11.

Sensitivity of 1-Poly(ethylenimine)-Carbon Black Detectors to Volatile Fatty Acids. The l-PEI-carbon black composites clearly displayed significant enhancements in sensitivity for detection of volatile fatty acids relative to the behavior of polymers such as poly(55% ethylene-co-45% vinylacetate), poly(ethylene oxide), and other materials that do not contain complimentary chemical functionality to the Bronsted acid groups that are present in the target analyte class (FIGS. 2 and 3). Use of plasticizers produced chemical diversity in the array of l-PEI chemiresistive vapor detectors while maintaining the high overall sensitivity of the l-PEI-based composites for the target class of analytes. Such an array is able to detect and robustly distinguish between these important biomarker analytes at significantly reduced vapor concentrations relative to the concentrations required to produce good signal/noise ratios on carbon black composite chemiresistors formed from polymers that do not contain such amine functionality.

Mechanism of Sensitivity Enhancement for 1-Poly(ethylenimine)-Carbon Black Vapor Detection of Volatile Fatty Acids. Analysis of the resistance, mass, and thickness changes for l-PEI films reveals that several different chemical factors determine the dc electrical response of this system in the presence of volatile fatty acid vapors. The response of l-PEI to methanol is relatively straightforward, and is well-described by a simple model involving sorption of analyte into the polymer film producing polymer swelling which in turn effects a change in the dc electrical resistance of the composite. In contrast, the sorption of acetic acid in l-PEI exhibits more complicated behavior, which is discussed below within the context of a model of the sorption and polymer response mechanism of l-PEI and acetic acid. Four striking features are readily apparent from the data of FIGS. 7 and 8 for sorption of acetic acid into l-PEI, as compared with the data of FIGS. 5 and 6 for sorption of methanol into l-PEI. First, the relative differential resistance change per unit of sorbed analyte increases as more analyte is sorbed into the film (FIG. 7b). Second, the relative differential thickness change per unit of sorbed analyte also increases as more analyte is sorbed into the film (FIG. 8b). Third, for 20% carbon black-l-PEI composites, the relative differential resistance change per unit of relative thickness change is the same for methanol and acetic acid at low sorbed analyte concentrations, but increased sorption of acetic acid produces much larger relative differential resistance responses per unit of thickness change (FIGS. 10a and b). Finally, the increase in relative differential resistance change per unit of relative thickness change is a function of the carbon black loading of the composite, with low loadings showing a significant increase in ΔRₘₐₓ/R_{b} at lower P/P° values than composites having higher carbon black loadings (FIG. 11).

The data can be consistently interpreted by reference to the following model for the processes that occur upon sorption of acetic acid into l-PEI films. (1) At low values of analyte sorption, the increased sensitivity of the l-PEI-carbon black composites to acetic acid vapor relative to methanol vapor is essentially entirely ascribable to an increase in the polymer/gas partition coefficient for acetic acid relative to that of methanol. Evidence supporting this conclusion is provided by the data of FIG. 10, in which the values of S_{R,h}=∂(ΔRₘₐₓ/R_{b})/∂(Δhₘₐₓ/h_{b}) at low h values are very similar for both acetic acid and methanol. Hence, once analyte is sorbed into the film, the l-PEI produces the same resistance change in response to the same volumetric swelling arising from sorption of either acetic acid or methanol. (2) At higher sorption values of acetic acid, secondary interactions presumably due to charge-charge repulsion between protonated positively charged polymer units produce an increase in the swelling of the film relative to the magnitude of the swelling that is expected for sorption of a non-acidic organic vapor such as methanol. Evidence supporting this conclusion is provided by the data of FIG. 8a, which show a marked increase in Δhₘₐₓ/h_{b} per amount of sorbed acetic acid above Δmₘₐₓ/m_{b}=0.3. The value of (S_{R,h} S_{h,A}) increases in this regimen in response to the increased swelling per unit of acetic acid sorption, as evidenced by FIG. 7. (3) A third effect is observed at still higher P/P° values of acetic acid, for composites having low carbon black loadings into the l-PEI composite detector films. As shown in FIG. 10b, S_{R,h}=∂(ΔRₘₐₓ/R_{b})/∂(Δhₘₐₓ/h_{b}) increases at very high swellings. This effect can be attributed to the production of sufficiently large sorption-induced film swellings to drive the l-PEI film through the percolation threshold, producing concomitant increases in S_{R,h} and therefore in the overall detector sensitivity to acetic acid, S_{R,A}, for the films having lower carbon black loadings and therefore lower values of their percolation thresholds (FIG. 11).

An interesting observation is that the values of ∂(ΔRₘₐₓ/R_{b})/∂[A]ₚ), after correction for the density differences between acetic acid and methanol, are very similar at low sorption values of both analytes. FIG. 11 displays a plot of ΔRₘₐₓ/R_{b} as a function of the volume of analyte sorbed into the film, where the sorbed analyte volume is computed from the sorbed mass multiplied by the density of the analyte in its liquid phase. Hence, at low sorption values, the magnitude of the film swelling is well described by the partition coefficient differences and the partial molar volume differences of the two analytes. An increase in ΔRₘₐₓ/R_{b} per unit of sorbed analyte volume is only observed at higher sorption values of acetic acid. Thus, it appears that acetic acid sorption takes place in two distinct regimes, one in which acetic acid does not induce any significant secondary interactions in the l-PEI film (in which the swelling is equivalent to that expected for any other analyte of the same partial molar volume swollen in the film), and a second regime in which sorption of acetic acid produces an increased signal resulting from the onset of secondary interactions and concomitant increases in film swellings and ΔRₘₐₓ/R_{b} values in response to increases in the acetic acid partial pressure.

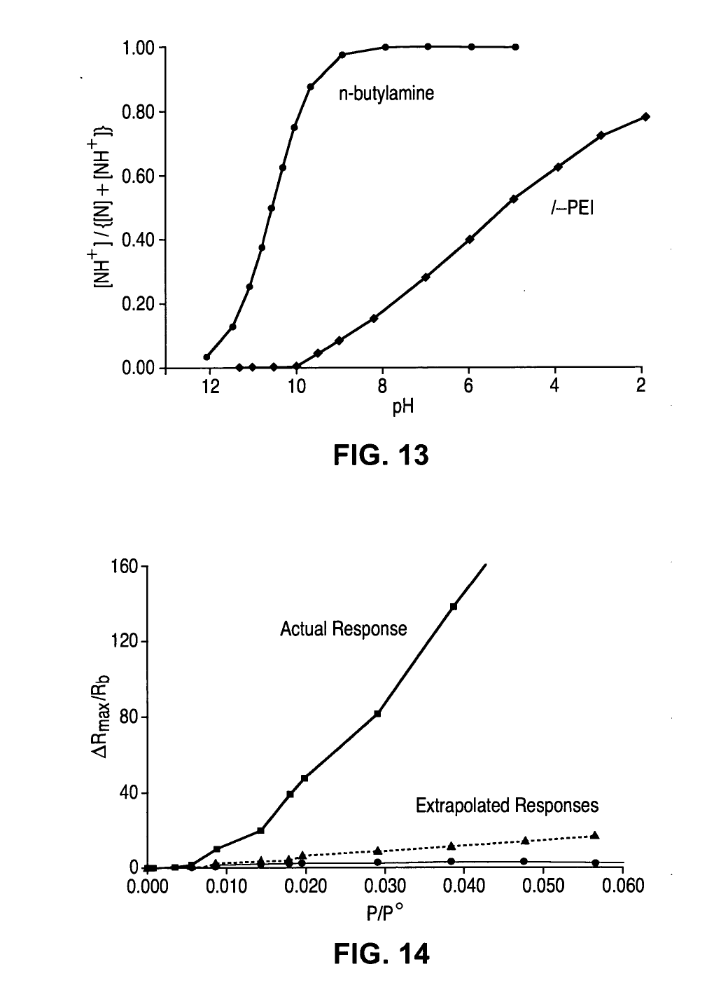

FIG. 13 summarizes data from Sub et al., who have investigated the protonation of l-PEI and of PEI derivatives as a function of the pH of an aqueous solution that is slowly titrated with 12 M HCI(aq). The amino groups of PEI initially resist protonation when titrated with acid, and this “delayed protonation” has been attributed to unfavorable energetics for the formation of the protonated polycation of PEI. For comparison, the titration curve expected for a typical monoprotic base, n-butylamine, does not show such an induction regime (FIG. 13). The data of FIGS. 7b, 8a and 12 are consistent with these observations, in that the repulsive interactions that accompany protonation of the polymer amine groups and hence produce increased swelling per unit of sorbed acetic acid increase at higher acetic acid levels in the polymer film.

For P/P°>0.01 of acetic acid, mass uptake, charge-induced swelling and percolation effects all contribute to the ΔRₘₐₓ/R_{b} signal observed for l-PEI-20% carbon black composites. The relative contributions of each of these effects can be estimated by reference to the properties of l-PEI films determined in FIGS. 6-10. The Δhₘₐₓ/h_{b} vs. Δmₘₐₓ/m_{b} data of FIG. 8b can be used to compute the relative thickness change expected for the l-PEI-20% carbon black composite of FIG. 7a at each value of P/P° of acetic acid. The ΔRₘₐₓ/R_{b} vs Δhₘₐₓ/h_{b} data for methanol (FIG. 10a) and/or the initial slope of ΔRₘₐₓ/R_{b} vs Δhₘₐₓ/h_{b} for acetic acid (FIG. 10b) can then be used to relate these Δhₘₐₓ/h_{b} values to the values of ΔRₘₐₓ/R_{b} that are expected due to swelling of a l-PEI-20% carbon black composite in the regime below the percolation threshold. Extrapolation of this relationship to higher P/P° values yields the behavior displayed in FIG. 14 for an l-PEI composite, producing the expected ΔRₘₐₓ/R_{b} vs P/P° behavior of such films for P/P°<0.06 of acetic acid in the absence of percolation effects. FIG. 12 can then be used to establish the range of acetic acid partial pressures for which only the partial molar volume of the sorbed analyte determines the thickness change of the l-PEI film. The agreement between the thickness change for sorbed methanol and sorbed acetic acid as calculated from the partial molar volumes of the two analytes indicates the absence of significant specific charge-induced swelling differences between the two analytes in this regime. Hence the data of FIG. 7b for Δmₘₐₓ/m_{b}<0.2 (corresponding to P/P°<0.005 from FIG. 7a) can be used to establish the proportionality between ΔRₘₐₓ/R_{b} and Δmₘₐₓ/m_{b} for the l-PEI-20% carbon black composite film in the absence of charge induced swelling effects. Extrapolation of this relationship between ΔRₘₐₓ/R_{b} and Δmₘₐₓ/m_{b}, in combination with the observed dependence of Δmₘₐₓ/m_{b} on P/P° of acetic acid that is displayed in FIG. 7a, yields the calculated dependence of ΔRₘₐₓ/R_{b} on P/P° for l-PEI-20% carbon black composites in the absence of charge-induced swelling or percolation effects. This calculated dependence for P/P°<0.06 of acetic acid is displayed as the lowermost curve in FIG. 14.

For P/P°≦0.005 of either methanol or acetic acid, ΔRₘₐₓ/R_{b} for acetic acid is larger than that for methanol by a factor of ≈10³. As the concentration of acetic acid is increased, the data of FIG. 9 show that the partition coefficient for sorption into l-PEI decreases somewhat relative to that of methanol. At P/P°=0.010 of methanol, the ΔRₘₐₓ/R_{b} is =0.006, and is solely a consequence of mass-induced swelling. In contrast, at P/P°=0.010 of acetic acid exposure, the same composite produced a ΔRₘₐₓ/R_{b} of =15. The difference in sorption of acetic acid vs methanol is =250 at this P/P° value, and produces an expected value of ΔRₘₐₓ/R_{b}=1.4 at this sorption level of acetic acid. Charge induced swelling of l-PEI contributes further to the ΔRₘₐₓ/R_{b} signal of the l-PEI-carbon black composites at this value of P/P°, producing an expected ΔRₘₐₓ/R_{b} value of =2.6, and therefore increasing ΔRₘₐₓ/R_{b} by a factor of 2-8 for acetic acid P/P° values in the range 0.010 to 0.06. At higher P/P° values, the partition coefficient for acetic acid decreases whereas that of methanol stays relatively constant, so the differences in ΔRₘₐₓ/R_{b} due to analyte sorption become smaller at higher analyte partial pressures. However, percolation effects play an increasingly dominant role at higher P/P° acetic acid exposures, increasing the ΔRₘₐₓ/R_{b} for l-PEI-20% carbon black composites by a factor of =10-20 for 0.010<P/P°<0.040 relative to the values expected in the absence of crossing the percolation threshold.

Applicability of the Carbon Black-l-Poly(ethylenimine) Sensitivity Gains for Volatile Fatty Acids to Other Vapor Detection Modalities. Methods to obtain increases in sensitivity can conceptually be divided into two different approaches. One tact involves increasing the sorption of analyte into a polymer film, while maintaining a constant signal transduction mechanism and therefore maintaining a constant numerical relationship between the amount of sorbed analyte and the amplitude of the detected signal per unit of sorbed analyte. This approach is most useful for analytes with high vapor pressures, which inherently generally have small polymer/gas partition coefficients. A sorption-based approach to sensitivity improvement can be beneficially used to increase the system sensitivity for a variety of transducers coated with the appropriate chemically complimentary polymer sorbent layer, such as dye-impregnated optical fibers and coated optical beads, surface acoustic wave devices, quartz crystal microbalances, micromachined cantilevers, chemically sensitive composite resistors, conducting polymer chemiresistors, and other vapor detectors for which the signal is proportional to the sorbed mass of analyte into a detection layer. The factors that control polymer/gas sorption processes have received much attention in support of this approach to gas sensor sensitivity enhancement. A significant portion of the sensitivity enhancement towards volatile fatty acids obtained from use of the l-PEI-based detectors originates from increased polymer/gas partition coefficients for organic acids (c.f. FIGS. 5a, 7a); hence this component of the sensitivity improvement observed herein ought to be applicable for l-PEI coatings when used in other types of sorption-based vapor detectors as well.

For low vapor pressure compounds, however, increasing the sorption coefficient will not in general produce significant gains in overall system performance. This limitation results from the fact that analytes with low vapor pressures will generally have high polymer/gas partition coefficients at low absolute vapor phase analyte concentrations because the thermodynamic activity of such compounds is relatively large even at small absolute vapor concentrations. Once the polymer/gas partition coefficient increases above a certain range, essentially all of the available mass in a finite volume of sampled analyte will be sorbed into the detector film, and increases in the polymer/gas partition coefficient will have little effect on the performance of such systems at low analyte concentration. For example, for a polymer/gas partition coefficient of 10×10⁷, a 2.6 cm² area of a detector film could sorb essentially all of the analyte in a 3.0×10⁻² cm thick headspace that is supplied at a continuous volumetric flow rate of 10 cm³ min⁻¹ for a period of 260 min. In this instance, the analyte detection and detected signal amplitude is, in practice, limited by mass transport of the analyte to the detector as opposed to the sorption/desorption equilibrium process. Hence improving the sorption coefficient will produce relatively little sensitivity gains for such types of analyte vapors.

A second approach to sensitivity enhancement involves exploiting chemical interactions that improve the signal transduction factor per unit of sorbed analyte in the detector film. This component of an increase in detector sensitivity will produce enhanced system performance under all detection conditions, provided that the noise of the detector is also not amplified. A significant component of the observed sensitivity enhancement for detection of organic volatile fatty acid vapors with l-PEI chemiresistive composites arises from this type of sensitivity enhancement mechanism (c.f. FIG. 13). This component of the sensitivity increase for the l-PEI-carbon black composite detectors will not be transferrable, in general, to other types of sorption detectors, but will instead only be exploitable for detector modalities that are sensitive to the underlying physicochemical change in the sorption layer that leads to the system sensitivity enhancement observed herein. For example, mass-based detectors such as QCM crystals and surface acoustic wave (SAW) devices would not be beneficially affected by the additional sensitivity gains observed for electrical detection of l-PEI-carbon black chemiresistors at acetic acid vapor pressures above P/P°=0.01 (c.f. FIG. 2a). Assuming a noise limit of 10 Hz, the QCM-based detection sensitivity for acetic acid using l-PEI coated crystals is approximately 1 order of magnitude lower than that of l-PEI-carbon black composite chemiresistors. This difference occurs because the underlying process that provides an improved chemiresistive detection system in this regime does not solely involve enhancements in mass uptake (FIG. 7a) but instead involves an enhancement in the electrical resistance response of the composite to mass uptake of the target class of analytes (FIGS. 10, 12). Volume-sensitive detection schemes, such as capacitive detectors could advantageously exploit this component of the sensitivity enhancement observed herein for the l-PEI-based materials sorbing organic acids. However, due to the compensating factors described above, the volume expansion is a relatively constant function of analyte vapor pressure for l-PEI sorbing acetic acid (c.f, FIG. 8a). An additional component of the observed sensitivity enhancement is unique to electrical resistance measurements, in that the relationship between volumetric swelling and electrical conductivity of the l-PEI-carbon black composites is a function of the electrical conductance properties of the percolative network of carbon black particles in the conductor/insulator composite detector films. This component of the sensitivity enhancement observed herein is unique to detectors that probe the change in percolative network properties of the composite films, such as chemiresistive detectors (c.f. FIGS. 7a, 8a, and 11).

The l-PEI-carbon black composites thus show enhanced system sensitivity to volatile fatty acids because of exploitation of the unique amplification of analyte sorption into dc electrical resistance signals that are a consequence of the nature of the materials that can be exploited in the chemiresistive detector operational modality. The signal amplitude at low analyte concentrations is approximately linear with analyte partial pressure, minimizing demands on establishing a training set to robustly identify the analytes of interest. At higher analyte concentrations, the sensitivity of the detectors actually increases towards the fatty acids, but a non-linearity with respect to analyte concentration is introduced. The ability to robustly extract features associated with the desired analytes under such conditions in the presence of a variety of background ambients and/or interferences will require evaluation of such detector arrays under the specific tasks of interest. Similar approaches, with different polymer functionality to provide chemically complimentary interactions with other classes of target analytes, ought to yield similar sensitivity improvements towards other classes of analytes. Conducting polymer composites of these materials therefore provide an interesting approach for construction of vapor detector arrays for applications such as bacterial detection and classification, and for other applications in which volatile fatty acids are important vapor signatures. The approach also offers the possibility of obtaining similar sensitivity enhancements for other important classes of target analytes through implementation of analogous polymer design methods.

The use of basic, amine-containing polymers as the insulating component in chemiresistive vapor detectors produces significant enhancements in sensitivity to volatile organic fatty acid vapors relative to the use of carbon black composites formed from polymers that do not contain such complimentary chemical interactions. Additionally, l-PEI-carbon black-based detectors show selectivity towards volatile fatty acids compared to other organic vapors. Addition of varying amounts of plasticizer into such polymer films allows production of arrays of vapor detectors that can robustly discriminate between a series of volatile organic fatty acid vapors. Studies of the relative mass uptake vs. relative differential resistance response of these films have demonstrated that the dc electrical resistance response of these detectors is much larger for acetic acid than for methanol and that only a portion of this increase can be attributed to differences in polymer/gas partition coefficients for the two different analyte vapors. Swelling of the l-PEI films, as measured using ellipsometry, shows an additional increase in film thickness during sorption of acetic acid that is not observed during sorption of methanol. These enhanced swelling and resistance responses upon sorption of acetic acid into l-PEI are consistent with the generation of positive charges along the l-PEI polymer backbone due to proton transfer from the volatile acid to the amines in the polymer, causing charge related volume expansion of the swollen polymer film. Percolation effects play an increasingly large role in the ΔRₘₐₓ/R_{b} response of l-PEI-carbon black detectors at high (>−0.005) P/P° acetic acid values. For example, at P/P°=0.010, a 10⁴ increase in relative resistance response is observed for acetic acid compared to methanol exposed to a l-PEI 20% carbon black detector. Increased partition coefficients can account for ˜10³ of the signal increase at this P/P°, while charge-induced swelling nearly doubles the ΔRₘₐₓ/R_{b} response. Percolation further increases the detector response 5-6 fold for acetic acid at this P/P°, resulting in a detector capable of selective detection of volatile fatty acids at sensitivities that far exceed those of typical polymer-based carbon black composite chemiresistors.

1. A sensor, comprising:
regions of an amine-containing material and a conductive material, wherein the sensor provides an electrical path through the regions of the amine-containing material and the regions of the conductive material.

2. The sensor of claim 1, wherein the conductive material is carbon black.

3. The sensor of claim 1, wherein the conductive material is selected from the group consisting of Ag, Au, Cu, Pt, and AuCu.

4. The sensor of claim 1, further comprising a second conductive material compositionally different than the conductive material.

5. The sensor of claim 1, wherein the amine-containing material is selected from the group consisting of:
a polyimine selected from the group consisting of (acetyliminoethylene), polyethylenimine, and poly(valeryl-iminoethylene);
a polyallylamine;
a polyvinylamine;
a polyhistidine;
a polyomithine;
a polylysine; and
a polyarginine.

6. A sensor array comprising:
a plurality of sensors; and
a measuring apparatus, wherein the plurality of sensors are in communication with the measuring apparatus,
at least one sensor of the plurality of sensors comprising:
regions of a polyimine material and a conductive material, wherein the sensor provides an electrical path through the regions of the polyimine material and the regions of the conductive material, the sensors constructed to provide a first response when contacted with a first chemical analyte, and a second different response when contacted with a second different chemical analyte.

7. The sensor array of claim 6, wherein the measuring apparatus is an electrical measuring device in electrical communication with at least one sensor.

8. The sensor array of claim 6, wherein the array comprises a plurality of sensors each having regions of a polyimine material and a conductive material.

9. The sensor array of claim 6, wherein the at least one sensor comprises at least two sensors.

10. The sensor array of claim 9, wherein the at least two sensors comprise a different thickness than each other.

11. The sensor array of claim 6, wherein the conductive material is an inorganic conductor.

12. The sensor array of claim 11, wherein the inorganic conductor is selected from the group consisting of Ag, Au, Cu, Pt, and AuCu.

13. The sensor array of claim 6, wherein the response is a change in resistance in the sensors.

14. The sensor array of claim 6, further comprising a temperature control apparatus, the temperature control apparatus in thermal communication with at least one sensor in the sensor array.

15. The sensor array of claim 6, wherein the response is a change in impedance.

16. The sensor array of claim 6, wherein the conductive material is carbon black.

17. The sensor array of claim 6, wherein the conductive material is a member selected from the group consisting of a metal, a metal alloy, a metal oxide, an organic complex, a semiconductor, a superconductor and a mixed inorganic-organic complex.

18. The sensor array of claim 6, wherein the polyimine is selected from the group consisting of poly(acetyliminoethylene), poly ethylenimine, and poly(valeryl-iminoethylene).

19. The sensor array of claim 6, wherein the conductive material is a particle.

20. A sensor array system comprising:
a plurality of sensors; and a measuring apparatus, wherein the sensors are in communication with the measuring apparatus,
a computer comprising a resident algorithm,
at least one of the sensors comprising: regions of an amine-containing material and regions of a conductive material, wherein each sensor provides an electrical path through the region of the amine-containing material and the conductive material, the sensors constructed to provide a first response when contacted with a first chemical analyte, and a second different response when contacted with a second different chemical analyte, wherein the computer processes the difference between the first response and the second response and wherein the amine-containing material is selected from the group consisting of a polyimine selected from the group consisting of (acetyliminoethylene), polyethylenimine, and poly(valeryl-iminoethylene); a polyallylamine; a polyvinylamine; a polyhistidine; a polyomithine; a polylysine; and a polyarginine.

21. The sensor array system of claim 20, wherein the measuring apparatus is an electrical measuring device in electrical communication with at least one sensor.

22. The sensor array system of claim 20, wherein the amine-containing material of at least one sensor is different from the amine-containing material of at least one other sensor.

23. The sensor array system of claim 20, wherein the conductive material is an inorganic conductor.

24. The sensor array system of claim 20, wherein the response is a change in resistance in the sensors.

25. The sensor array system of claim 20, wherein the amine-containing material of the plurality of sensors are compositionally the same.

26. The sensor array system of claim 20, wherein the conductive material is selected from the group consisting of polyanilines, emeraldine salt of polyanilines, polypyrroles, polythiophenes, polyEDOTs, Ag, Au, Cu, Pt, carbon black, and AuCu.

27. The sensor array system of claim 20, wherein the response is a change in impedance.

28. The sensor array system of claim 20, wherein the conductive material is carbon black and the amine-containing material is poly(ethylenimine).

29. The sensor array system of claim 20, wherein the resident algorithm is a member selected from the group consisting of principal component analysis, Fisher linear analysis, neural networks, genetic algorithms, fuzzy logic, pattern recognition, and combinations thereof.

30. A method for detecting the presence of an analyte in a sample, the method comprising:
sensing the presence of an analyte in a sample with a sensor array, wherein at least one sensor of the sensor array comprises a region of an amine-containing material and a region of a conductive material, the array of sensors providing a first response when contacted with a first sample comprising a first chemical analyte and a second different response when contacted with a second sample comprising a second different chemical analyte.

31. The method of claim 30, wherein each sensor in the sensor array is a chemiresistor comprising regions of a first material and regions of a second material compositionally different than the first material and wherein one sensor of the sensor array comprises a region of an amine-containing material and a region of a conductive material.

32. The method of claim 30, wherein each of the sensors in the array comprise a region of an amine-containing material and a region of a conductive material.

33. The method of claim 32, wherein the amine-containing material of at least one sensor is different from the amine containing material of at least one other sensor.

34. The method of claim 30, wherein the conductive material is an inorganic conductor.

35. The method of claim 30, wherein the response is a change in resistance in the sensors.

36. The method of claim 30, wherein the response is a change in vibration.

37. The method of claim 30, wherein the conductive material is selected from the group consisting of a conductive organic material and a conductive inorganic material.

38. The method of claim 37, wherein the conductive organic material is selected from the group consisting of a polyaniline, an emeraldine salt of polyaniline, a polypyrrole, a polythiophene, a polyEDOT, and a carbon black, and the conductive inorganic material is selected from the group consisting of Ag, Au, Cu, Pt, and AuCu.

39. The method of claim 30, wherein the response is a change in impedance.

40. The method of claim 30, wherein the conductive material is selected from the group consisting of an organic conductor, an inorganic conductor, and a mixed inorganic-organic conductor.

41. The method of claim 30, wherein the conductive material is selected from the group consisting of a metal, a metal alloy, a metal oxide, an organic complex, a semiconductor, a superconductor, and a mixed inorganic-organic complex.

42. The method of claim 30, wherein the analyte is a carboxylic acid-containing molecule.

43. The method of claim 42, wherein the carboxylic acid-containing molecule is a fatty acid molecule.

44. A method for detecting a microorganism, the method comprising:
exposing an analyte mixture obtained from a sample to a sensor array comprising a plurality of sensors, wherein at least one sensor of the plurality of sensors comprises a region of an amine-containing material and a region of a conducting material; and
measuring a response from the plurality of sensors wherein an analyte in the analyte mixture is produced by a microorganism thereby detecting the microorganism.

45. A system for identifying an analyte, the system comprising:
a sensor array comprising a plurality of sensors connected to a measuring apparatus, wherein at least one sensor of the plurality of sensors comprises a region of an amine-containing material and a region of a conductive material and
a computer comprising a resident algorithm; the measuring apparatus capable of detecting a response from each sensor and the computer capable of assembling the responses into a response profile for analyte identification.

46. The system of claim 45, wherein the resident algorithm of the computer is selected from the group consisting of principal component analysis, Fisher linear analysis, neural networks, genetic algorithms, fuzzy logic, pattern recognition, and combinations thereof.

47. The system of claim 45, further comprising the steps of:
providing an information storage device coupled to the measuring apparatus; and
storing information in the information storage device.

48. The system of claim 45, wherein the measuring apparatus includes a digital-analog converter.

49. The system of claim 45, wherein the measuring apparatus is optimized to detect electromagnetic energy, optical properties, resistance, capacitance, inductance, impedance, and combinations thereof.

50. The system of claim 45, wherein the array of sensors comprises a member selected from the group consisting of a surface acoustic wave sensor, a quartz microbalance sensor; a conductive composite; a chemiresistor; a metal oxide gas sensor and a conducting polymer sensor, a dye-impregnated polymer film on fiber optic detector, a polymer-coated micromirror, an electrochemical gas detector, a chemically sensitive field-effect transistor, a carbon black-polymer composite, a micro-electro-mechanical system device and a micro-opto-electro-mechanical system device.

51. The system of claim 45, wherein the analyte is an off gas of a microorganism selected from the group consisting of Prevotella intermedia, Fusobacterium nucleatum, Porphyromonas gingivalis, Porphyromonas endodontalis, Prevotella loescheii, Hemophilus parainfluenzae, Stomatococcus muci, Treponema denticola, Veillonella species, Peptostreptococcus anaerobius, Micros prevotii, Eubacterium limosum, Centipeda periodontii, Selemonad aremidis, Eubacterium species, Bacteriodes species, Fusobacterium periodonticum, Prevotella melaninogenica, Klebsiella pneumoniae, Enterobacter cloacae, Citrobacter species and Stomatococcus mucilaginus.

52. A method for detecting a disease in a subject, the method comprising,
contacting an array of sensors with a biological sample suspected of containing an analyte indicative of the disease, wherein at least one sensor of the array of sensors comprises regions of an amine-containing material and a conductive material; and
detecting the analyte wherein the presence of the analyte is indicative of the disease.

53. the method of claim 52, wherein the array of sensors comprises a sensor selected from the group consisting of a surface acoustic wave sensor, a quartz microbalance sensor; a conductive composite; a chemiresistor; a metal oxide gas sensor and a conducting polymer sensor, a dye-impregnated polymer film on fiber optic detector, a polymer-coated micromirror, an electrochemical gas detector, a chemically sensitive field-effect transistor, a carbon black-polymer composite, a micro-electro-mechanical system device, and a micro-opto-electro-mechanical system device.

54. The method of claim 52, further comprising obtaining a response from the sensors and inputting the response to a neural net trained against known analytes.

55. The method of claim 52, wherein the disease is selected from the group consisting of halitosis, periodontal disease, pneumonia, vaginitis, uremia, trimethylaminuria, lung cancer, dysgensia, dysosnia, cytinuria, and bacterial vaginosis.

56. The method of claim 52, wherein the analyte is an off gas of an organism selected from the group consisting of Prevotella intermedia, Fusobacterium nucleatum, Porphyromonas gingivalis, Porphyromonas endodontalis, Prevotella loescheii, Hemophilus parainfluenzae, Stomatococcus muci, Treponema denticola, Veillonella species, Peptostreptococcus anaerobius, Micros prevotii, Eubacterium limosum, Centipeda periodontii, Selemonad aremidis, Eubacterium species, Bacteriodes species, Fusobacterium periodonticum, Prevotella melaninogenica, Klebsiella pneumoniae, Enterobacter cloacae, Citrobacter species and Stomatococcus mucilaginus.

57. The method of claim 52, wherein the biological sample is a subject's breath, vaginal discharge, urine, feces, tissue sample, or blood sample.
